(19) United States
(12) Patent Application Publication
(10) Pub. No.: US 2014/0368032 A1
(43) Pub. Date: Dec. 18, 2014

(54) Network infrastructure component, network system having a plurality of network infrastructure components, and use of the network system

(71) Applicant: Ropa Development GmbH, Schwaebisch Gmuend (DE)

(72) Inventor: Johannes Doerndorfer, Schwaebisch Gmuend (DE)

(21) Appl. No.: 14/472,883

(22) Filed: Aug. 29, 2014

Related U.S. Application Data
(63) Continuation of application No. PCT/EP2013/054192, filed on Mar. 1, 2013.

(30) Foreign Application Priority Data
Mar. 2, 2012 (DE) 10 2012 101 799.9

(51) Int. Cl. H02J 4/00

(52) U.S. Cl. CPC H02J 4/00
USPC 307/20

(57) ABSTRACT

The invention relates to a network infrastructure component and a distributed network system for supply purposes comprising a plurality of network infrastructure components, wherein the network infrastructure component comprises at least one contact unit for connection to a further network infrastructure component, and at least one coupling module for coupling a functional group, wherein the network infrastructure component is designed to communicate with a coupled functional group at least at a supply level, wherein the network infrastructure component is designed to communicate with at least one further network infrastructure component at least at the supply level and/or a data level, such that a self-configured network system for linking a plurality of functional groups can be produced with a network of a plurality of network infrastructure components. Preferably, the network infrastructure component comprises a control device for controlling operating parameters, in particular for load control at the supply level.

### CROSS-REFERENCE TO RELATED APPLICATIONS

This is a Continuation application of International patent application PCT/EP2013/054192, filed Mar. 1, 2013, which claims the priority of German patent application DE 10 2012 101 799.9, filed Mar. 2, 2012.

### BACKGROUND OF THE INVENTION

The present invention relates to a network infrastructure component comprising at least one contact unit for connection to a further network infrastructure component, and comprising at least one coupling module for coupling a functional group, wherein the network infrastructure component is designed to communicate with a coupled functional group and with at least one further network infrastructure component at least at a supply level. The invention furthermore relates to a network system comprising a plurality of such network infrastructure components, and to uses of such a network system.

Network infrastructure components, also designated as nodes, on account of their coupling functionality, can make it possible to construct networks in which a plurality of network infrastructure components are coupled to one another indirectly or directly. In this case, a plurality of the network infrastructure components can be designed to communicate with at least one functional group coupled thereto.

In this way, for instance, supply networks (also designated as meshed networks or as mesh), for example electricity networks (also designated as so-called grids), can be realized. Such a supply network can be configured to distribute a network medium (alternatively: a plurality of network media) in a manner conforming to demand. Network participants can be, for instance, generators, sources, sinks, consumers, buffers, stores or the like. These can be coupled as so-called functional groups to the network system (network). It goes without saying that individual functional groups can take on a plurality of the abovementioned roles simultaneously or alternately over time.

US 2009/0088907 A1 discloses an electricity network comprising a modular interface device (so-called Smart Grid Gateway) for managing and controlling generators, stores and consumers. US 2008/0052145 A1 discloses a system for aggregating distributed electrical resources. DE 10 2009 044 161 A1 discloses a system and a method for controlling energy generating, storage and/or consumption units coupled to one another. Furthermore, US 2009 0030712 A1 discloses a system for coupling a vehicle to an electricity network.

Various approaches for realizing electricity networks are known. By way of example, in the public electricity network, consumers at different voltage levels are supplied with electrical energy, which are in turn fed into the electricity network from different sources at different voltage levels. The consumers can be, for instance, households, commercial small and large industrial enterprises having greatly divergent demands. There is often a broad spectrum on the generator side as well, for example wind power installations, solar power plants, biogas installations, combined heat and power plants, hydroelectric power plants, large power plants, nuclear power plants or the like, which have characteristic power ranges and can feed in continuously or else to a greater or lesser extent with fluctuations. In line with the characteristics on the generator side and the consumer side, in the electricity network there are different voltage levels which can be coupled to one another via substations, for instance. The voltage levels can comprise, for example, extra high voltage, high voltage, medium voltage and low voltage. In order to maintain the equilibrium between generators and consumers, it is necessary to provide entities which can connect or disconnect capacities in a consumption-dependent manner, for instance. Such network management can be based on empirical values, for example, such as day-night fluctuations or seasonal fluctuations. However, it is not possible to exactly detect the demand from consumers before they are coupled to the electricity network and demand power. For this reason and to provide a cushion for accommodating spontaneous peak loads, it is necessary for a power reserve always to be kept available in the electricity network.

However, an electricity network can also be realized on a smaller scale, for example in the case of an electric vehicle or in the case of a “network-independently” operated tool with rechargeable batteries. An electric vehicle can be, for instance, an electric bicycle, a so-called pedelec, a car having a pure electric drive or having a so-called hybrid drive, a vehicle for industrial use, for example a lifting truck or a forklift truck, or the like. Network-independent hand tools are known, for instance, as cordless screwdrivers or cordless drills. Almost all known systems for network-independent energy supply are designed as so-called proprietary systems. That is to say that system components are regularly designed system-specifically, in particular manufacturer-specifically. In other words, it is not possible to couple energy consumers or energy stores of different systems to one another in order, for instance, to transmit available residual energy from one system to another system.

Furthermore, initial approaches for intelligent electricity networks (so-called Smart Grids) are known. One such approach is based on establishing a data network alongside the actual electricity network, in order to be able to exchange operating data between generators and consumers. In the case of a Smart Grid, by way of example, domestic technology can be coupled as consumer to the electricity network deliberately when a present dip in demand leads to a low (instantaneous) electricity price. However, Smart Grid Systems require a superordinate central control structure. Structural stipulations are an obstacle to further flexibilization.

A further example of an application with a bundling of electricity conduction and data conduction is the so-called EnergyBus Standard for mobile applications, in particular for mobile light vehicles. The aim of the standard is to provide stipulations for system components involved, in order to move away from proprietary to “open” drive systems for electric vehicles. For this purpose, the intention is to standardize energy stores and charging stations, for instance, to the effect that cross-manufacturer compatibility is achieved. In the case of the EnergyBus standard, the energy stores themselves have a control system that is designed to control charging processes and power outputs. In this way, in the case of the EnergyBus standard, for instance, a plurality of energy stores (batteries) can be coupled to one another in parallel. An EnergyBus standard-conforming system is scalable within certain limits.

From the field of information technology, various standards are known which enable both (electrical) energy and data to be transmitted in a network. They include, for instance, the Universal Serial Bus (USB) standard and the Power over Ethernet (PoE) standard. In these systems, however, the transmission of energy recedes into the background compared with the transmission of data. Such standards do not make it possible to construct a network which serves substantially for energy supply.

Further approaches for buslike networks for supplying electricity and transmitting data can be found in automation technology and in vehicle technology. There are hardly any established standards particularly in the vehicle sector. A possible maximum power of a consumer coupled to an onboard network can fluctuate greatly in a vehicle-specific manner, for instance. Consequently, voltage drops, overloads, triggering of fuses or even more extensive damage in vehicle electronics can often be observed on a routine basis.

Further challenges arise in the field of electromobility. With increasing market penetration it can be assumed that more pronounced fluctuations will occur in the public electricity network. This is the case particularly if a large number of electric vehicles are intended to be charged from the electricity network simultaneously in a spatially concentrated manner. From the standpoint of the conventional electricity network, the coupling of further consumers cannot be prevented in the case of imminent overloading, for instance, with the result that, under certain circumstances, the only reaction of the network to the overloading that then occurs is a network collapse.

One possible way of avoiding this problem might consist, for instance, in making complete battery units exchangeable and keeping them available for exchange at corresponding “filling stations”. However, such an approach has the drawback that known battery units for electric vehicles are designed, in principle, vehicle-specifically or manufacturer-specifically.

In a similar manner, in the case of commercially available network-independent electric tools, for instance, at best rechargeable batteries can be exchanged between similar devices from a manufacturer. Among manufacturers, in principle, different standards and connection dimensions are manifested.

In order to be able to cover power ranges required for electric vehicles, for instance, a multiplicity of (rechargeable battery) cells are regularly coupled to one another in battery units. Individual cells are subject to a statistical probability of failure and reduction of performance over the lifetime. Particularly in the case of cells interconnected in series with one another, failures or power losses at the level of the individual cell can cause power losses or even failures of the entire battery unit.

With the purchase of an electric vehicle or a network-independently operable hand tool, consumers often enter into a forced relationship with a single manufacturer concerning the energy store. Despite the fact that the energy stores are merely intended to make electrical energy available in a specific way, a multiplicity of manufacturer-specific contacts, geometries and similar boundary conditions lead to an immense diversity of parts. This is accompanied by correspondingly high production costs and logistical costs.

From the point of view of manufacturers, proprietary energy storage systems give rise to various disadvantages. Energy stores have to pass mechanical loading tests, inter alia, in order to obtain market readiness. Particularly in the case of lithium-ion-based batteries, there can be the threat of a fire hazard after mechanical damage. As the number of variants increases, there is consequently also an increase in the outlay for measurements and tests in order to prove suitability for series production.

If systems which are electrically incompatible with one another are present, for example chargers and battery units from different manufacturers, it may even be desired to provide mechanical incompatibility as well, in order to avoid inadvertent coupling of such devices. Such an indirect coupling could firstly have the effect that the battery unit is not fully charged; secondly, damage through to a fire hazard can occur both in the case of the battery and in the case of the device. As battery units become increasingly widespread for a variety of different usages, the classification of specific types of battery as hazardous material also comes to the fore. In this regard, for lithium-ion batteries, for instance, depending on their capacity or weight, there are different transport and storage regulations focused, in particular, on the risk of igniting.

The present incompatibility of existing energy stores actually has the effect, however, that, for instance, manufacturers, wholesalers, retailers and even consumers keep and use in their environment more energy stores than would actually be necessary from the point of view of demand.

In this regard, for instance, logistics service providers have to keep a large number of product-specific battery units and supply them as required. Battery packs can have the particular characteristic, however, of being subject to a deep discharge if they are stored for an excessively long time. This can be accompanied by power losses during later use or even a complete defect. Charging processes that may be required in order to maintain the lifetime during storage contribute to a further increase in the logistical costs and thus the system costs.

Finally, the immense diversity of variants and the incompatibility of different battery units are also disadvantageous at the end of the life cycle. Firstly, battery packs comprise sought-after and expensive raw materials. Secondly, the abovementioned problems can occur precisely in the case of recycling as well.

In general, it can be stated that known power supply networks, in particular those with essential incorporation of battery units, are subject to various disadvantages. Even in advanced networks, such as, for instance, in Smart Grid networks or EnergyBus networks, genuinely demand-conforming regulation and control cannot be carried out. Rather, even networks such as those are subject to relatively rigid restrictions, primarily with regard to control by a superordinate, central entity.

### BRIEF SUMMARY OF THE INVENTION

It is an object of the invention to specify a network infrastructure component and a network system comprising a plurality of network infrastructure components which enable flexible configuration and structuring of supply networks which can be extended flexibly, have a high component compatibility and can meet the challenges which arise in particular as a result of the emerging electromobility and the incorporation of decentralized (regenerative) energy supply systems and storage systems in supply network structures.

According to an aspect of the invention, there is provided a network infrastructure component comprising the following: at least one contact unit for connection to a further network infrastructure component, at least one coupling module for coupling a functional group, wherein the network infrastructure component is designed to communicate with a coupled functional group at least at a supply level, wherein the network infrastructure component is designed to communicate with at least one further network infrastructure component at least at the supply level and/or a data level, such that a self-configured network system for linking a plurality of functional groups can be produced with a network of a plurality of network infrastructure components.

According to a further aspect, there is provided a distributed network system for supply purposes, which is designed for transporting a network medium at a supply level, comprising a plurality of coupled network infrastructure components each comprising at least one contact unit for connection to a further network infrastructure component, at least one coupling module for coupling a functional group, wherein the network infrastructure component is designed to communicate with a coupled functional group at least at a supply level, wherein the network infrastructure component is designed to communicate with at least one further network infrastructure component at least at the supply level and/or a data level, such that a self-configured network system for linking a plurality of functional groups can be produced with a network of a plurality of network infrastructure components.

According to a further aspect, there is provided a method comprising the step of using a distributed network system for supply purposes for the drive of a vehicle with an at least partly electrical drive, wherein the distributed network system is designed for transporting a network medium at a supply level, comprising a plurality of coupled network infrastructure components each comprising the following: at least one contact unit for connection to a further network infrastructure component, at least one coupling module for coupling a functional group, wherein the network infrastructure component is designed to communicate with a coupled functional group at least at a supply level, wherein the network infrastructure component is designed to communicate with at least one further network infrastructure component at least at the supply level and/or a data level, such that a self-configured network system for linking a plurality of functional groups can be produced with a network of a plurality of network infrastructure components. According to a further aspect, there is provided a method comprising the step of using a distributed network system for supply purposes for the drive of a vehicle with an at least partly electrical drive, wherein the distributed network system is designed for transporting a network medium at a supply level, comprising a plurality of coupled network infrastructure components each comprising the following: at least one contact unit for connection to a further network infrastructure component, at least one coupling module for coupling a functional group, wherein the network infrastructure component is designed to communicate with a coupled functional group at least at a supply level, wherein the network infrastructure component is designed to communicate with at least one further network infrastructure component at least at the supply level and/or a data level, such that a self-configured network system for linking a plurality of functional groups can be produced with a network of a plurality of network infrastructure components.

According to a further aspect, there is provided a method comprising the step of using a distributed network system for supply purposes as supply system for regenerative energies, wherein the distributed network system is designed for transporting a network medium at a supply level, comprising a plurality of coupled network infrastructure components each comprising the following: at least one contact unit for connection to a further network infrastructure component, at least one coupling module for coupling a functional group, wherein the network infrastructure component is designed to communicate with a coupled functional group at least at a supply level, wherein the network infrastructure component is designed to communicate with at least one further network infrastructure component at least at the supply level and/or a data level, such that a self-configured network system for linking a plurality of functional groups can be produced with a network of a plurality of network infrastructure components.

According to a further aspect, there is provided a method comprising the step of using a distributed network system for supply purposes for operating network-independent electric tools, wherein the distributed network system is designed for transporting a network medium at a supply level, comprising a plurality of coupled network infrastructure components each comprising the following: at least one contact unit for connection to a further network infrastructure component, at least one coupling module for coupling a functional group, wherein the network infrastructure component is designed to communicate with a coupled functional group at least at a supply level, wherein the network infrastructure component is designed to communicate with at least one further network infrastructure component at least at the supply level and/or a data level, such that a self-configured network system for linking a plurality of functional groups can be produced with a network of a plurality of network infrastructure components.

According to a further aspect, there is provided a method comprising the step of using a distributed network system for supply purposes as buffer store for foreign networks, wherein the distributed network system is designed for transporting a network medium at a supply level, comprising a plurality of coupled network infrastructure components each comprising the following: at least one contact unit for connection to a further network infrastructure component, at least one coupling module for coupling a functional group, wherein the network infrastructure component is designed to communicate with a coupled functional group at least at a supply level, wherein the network infrastructure component is designed to communicate with at least one further network infrastructure component at least at the supply level and/or a data level, such that a self-configured network system for linking a plurality of functional groups can be produced with a network of a plurality of network infrastructure components.

According to a further aspect, there is provided a method comprising the step of using a distributed network system for supply purposes as change station for exchanging energy stores, wherein the distributed network system is designed for transporting a network medium at a supply level, comprising a plurality of coupled network infrastructure components each comprising the following: at least one contact unit for connection to a further network infrastructure component, at least one coupling module for coupling a functional group, wherein the network infrastructure component is designed to communicate with a coupled functional group at least at a supply level, wherein the network infrastructure component is designed to communicate with at least one further network infrastructure component at least at the supply level and/or a data level, such that a self-configured network system for linking a plurality of functional groups can be produced with a network of a plurality of network infrastructure components.

A network infrastructure component (also designated in a simplified way as node) can provide the functionality of a node point in a network system (also designated in a simplified way as network). Such a node point can communicate with further node points (network infrastructure components), such that the network system overall can provide a functionality which can come close or equate to self-management or self-control. A functional group coupled to the network infrastructure component is physically connected only to the latter, but can be “noticeable” indirectly to further network infrastructure components in the network system since the individual network infrastructure components can exchange data with one another.

The functional group can be, for instance, a generator, a store, a sink, or a consumer, but likewise also a coupling to a (foreign) network. It goes without saying that mixed forms are also conceivable, for instance a functional group which can occur temporarily as consumer, store and/or generator.

In other words, the network infrastructure component can provide the functionality of a “plug” for the network system. However, such a “plug” is not blindly plugged into the system, but rather can exchange data with its directly or indirectly adjacent plugs, which data can describe, for instance, the coupled functional groups in the network system.

The subdivision of “plug connections” into contact units and coupling modules can ensure that components to be connected to the network infrastructure component are correctly assigned. By means of a plurality of network infrastructure components connected to one another by means of the respective contact units, the “intelligence” of the network system can be realized network-internally.

It is furthermore preferred if the network infrastructure component comprises a control device for controlling operating parameters, in particular for load control at the supply level.

The control device can control the communication of the coupled functional group at the supply level in a desired manner. This can involve, for instance, feeding into the network system or drawing from the network system.

The control device can furthermore be designed to exchange operating parameters such as consumption data, capacities, power requirements, power provisions or the like with further coupled network infrastructure components at the data level.

It goes without saying that the control device of the network infrastructure component can also perform control tasks of a further coupled network infrastructure component. As an alternative thereto, it is conceivable to provide in the network system exclusively network infrastructure components whose (internal) controlling is performed by their own control device, wherein the control devices can effect exchange among one another for coordination purposes.

In accordance with a further refinement, the control device is furthermore designed to detect characteristic data of the coupled functional group, in particular at the supply level and/or the data level.

In this way, the network infrastructure component can also communicate with the coupled functional group at the data level. By way of example, identification data of the functional group can be fed to the control device. Furthermore, for instance, static or dynamic operating parameters can be taken into account by the control device in the load control.

In the network system, the network infrastructure components can effect exchange with regard to the characteristic data of their coupled functional groups. In association with this, coordinated load control at the supply level in the network system can result, although this controlling is carried out by distributed control devices of individual or all network infrastructure components.

Consequently, the network system can be autonomously independently controllable. In particular, there is no need for a superordinate supervisory and control entity that performs central load control.

In accordance with a further refinement, the control device is designed to take account of operating parameters of at least one further contacted network infrastructure component during the control.

This measure can contribute to enlarging the database provided for load control. In other words, by means of the data exchange in the case of the control device of the network infrastructure component, by way of example, a loading of the network system by remote functional groups that are not directly coupled can be made “visible” or be “simulated”. Integrated load control taking account of a total load attributed to individual distributed functional groups in the network system can be carried out in this way. An “organic” system can be realized which is nevertheless open, flexible and extendible.

In accordance with a further refinement, the control device is designed to communicate detected operating parameters at the data level to at least one further contact-contacted network infrastructure component.

It is thus conceivable to provide network infrastructure components which are “passive” or “active” with regard to their control device and which, for instance, are controlled by their adjacent network infrastructure components or else have a controlling effect on the latter. It goes without saying that the classification “passive network infrastructure component” or “active network infrastructure component” can be made logically at a program level or else structurally by the provision of corresponding components.

In accordance with a refinement, the network infrastructure component furthermore comprises at least one sensor element, in particular a temperature sensor and/or an acceleration sensor, wherein the at least one sensor element can be addressed by the control device.

In this way, further data can be detected and used for the load control of the network system. In particular, potentially harmful operating conditions can be identified. By way of example, by means of the acceleration sensor, mechanical damage can be identified and action to influence the network system can be brought about in order to avoid consequential damage. In this way, in the case of an electric vehicle, for instance, an automatic supervised discharging process can be initiated after an accident.

The temperature sensor can detect data which make it possible to deduce, for instance, a present loading of the network infrastructure component or of the functional group coupled thereto. Furthermore, a temperature detection allows a conclusion to be drawn about ambient conditions, according to which the load control can be correspondingly adapted. In this regard, it is known that usable battery capacities can be dependent on ambient temperatures.

In a refinement, the network infrastructure component is furthermore designed to communicate with at least one further network infrastructure component and/or the coupled functional group at an auxiliary energy level, in particular an auxiliary voltage level.

A “wake-up functionality” can be realized by means of this measure. The auxiliary voltage level can allow, for example, the control device, the sensor elements, further network infrastructure components and comparable components on the part of the coupled functional group to be supplied with an operating voltage. In this way, for instance, characteristic data and operating parameters of the network system can be detected and evaluated before network media are conducted at the supply level. As a result, by way of example, imminent overloading of the network system can be identified before it actually occurs. Consequently, the operating reliability of the network system can be improved further. An extension or reinstallation of a network system need no longer be carried out according to the trial-and-error method, in which overloads that possibly occur cannot be discerned until operationally in the course of operation.

In accordance with a further refinement, the network infrastructure component comprises an authentication unit for a user, in particular wherein said authentication unit is coupled to the control device.

In addition, it is also conceivable for the network infrastructure component to comprise an authentication unit, the data of which are fed to the control device of a further network infrastructure component coupled thereto.

The authentication unit may allow role-based or rule-based access control. Only authorized user groups can put the network system into operation and/or perform more extensive inputs or changes. In this regard, it is conceivable to “fix” an existing network system in order to prevent manual addition of further network infrastructure components by unauthorized users.

An authentication can be carried out in a key-based manner, for instance. Preferably, an authentication is carried out substantially contactlessly, for example by means of an RFID key.

In accordance with a further refinement, the control device provides rule-based access rights for a user.

Access rights configured in such a way can make possible, for instance, manual interventions in the control device and thus in the load control by authorized users. The authorization for this can be effected, for instance, by the authentication unit or else by a functional group which is coupled to the network infrastructure component. This can involve a server, for instance, which is connected to the coupling module wirelessly or in a wire-based fashion. It goes without saying that the network system can have, in principle, internal autonomous load control. Nevertheless, this does not militate against enabling monitoring or controlling interventions from outside.

In accordance with a further refinement, the control device is designed to carry out load limiting and/or load disconnection for the coupled functional group.

In this way, particularly with the evaluation of the characteristic data or operating parameters obtained, “software protection” can be realized. Particularly in the case of imminent damage or even potential danger, it is recommendable if the network system can automatically disconnect or isolate functional groups.

In accordance with a further refinement, the communication at the data level with the at least one further network infrastructure component and/or the coupled functional group is carried out by means of wireless data transmission, preferably by means of electromagnetic waves, with further preference by means of RFID technology.

By way of example, the functional groups and/or the network infrastructure components can have, particularly in the region of respective contact units or coupling modules, RFID transponders which can be read by the respective coupling partner. The transponders can be configured as active or passive transponders, for instance.

In this regard, for instance, on an RFID transponder of a functional group to be coupled, connection data and characteristic values can be stored which allow the network infrastructure component to assess whether the load to be incorporated is manageable for the network system.

It is furthermore conceivable to provide, on both sides of a connection, for instance between two network infrastructure components or between a network infrastructure component and a functional group, respectively transponder and reader in order to be able to exchange data of high value in both directions as required. This can be carried out, for instance, in duplex operation or sequentially.

Wireless communication at the data level allows a consistent separation between the supply level and the data level and can further reduce the risk of incorrect contact-connections, plug defects or the like. It goes without saying that transponder and/or sensor can be installed directly at a coupling location, but no direct (electrical) contact-connection is required.

In accordance with a further refinement, the network infrastructure component comprises an identification unit, which allows the network infrastructure component and each coupling module and/or each contact unit to be unambiguously identified.

In this way, even in a large distributed system, even with (initially) unknown topology, each partial element is unambiguously identifiable and addressable. Consequently, assignment tables or protocol tables can be generated without manual interventions. External monitoring is simplified.

There is furthermore provided a distributed network system for supply purposes, which is designed for transporting a network medium at a supply level, comprising a plurality of coupled network infrastructure components according to any of the previous aspects and refinements.

In principle, there are no restrictions with regard to the choice of network medium. The network medium can be electrical energy, for instance, wherein the supply level can be designed, in particular, as a DC voltage network. A DC voltage network is recommended in particular for network systems which are supplied at least partly by electrical energy stores, in particular rechargeable batteries or battery units.

Alternatively, the network medium can be, for instance, water, gas, compressed air, oil, likewise for instance also energy forms such as heat, for example water vapor or hot water, or cold, for example cold air.

Advantageously, the network system can have virtually any desired topology without significant restrictions. The network infrastructure components can be interlinked for instance in series, in a ring-shaped fashion, in meshes or in mixed forms. It is particularly preferred if the network system is embodied as a meshed network, that is to say that every network infrastructure component is directly or indirectly connected to every other network infrastructure component. It is furthermore particularly advantageous if at least partly redundant connections are present. In other words, it is preferred if an arbitrary network infrastructure component can be reached in at least two or more possible ways from the point of view of another network infrastructure component.

Such a network system can be made highly self-initializing and self-configuring. This ability can also be designated as “ad hoc” functionality. In contrast to known Smart Grid systems, a mandatory superordinate entity for control purposes can be dispensed with. The possibility of detecting characteristic data of a functional group to be coupled allows a so-called “plug and play” functionality. New network infrastructure components and/or new functional groups can be coupled to a running network system without disadvantageous effects, disturbances or potential component defects having to be feared.

In accordance with a refinement of the network system, the network infrastructure components can be coupled to in each case at least one functional group designed as consumer, supplier and/or store.

The coupling can be carried out indirectly or directly, in principle. It goes without saying that a substructure of functional groups can also be coupled to the network infrastructure components, for example a combination of a plurality of energy stores.

It goes without saying that a functional group can have properties of a consumer, supplier and/or store simultaneously or successively over time.

The functional groups can be, for instance, rechargeable batteries, battery packs, generators, motors, capacitors (for instance supercaps), but also furthermore monitoring units for monitoring purposes. Particularly if both consumers and suppliers are present in the system, this can result in complete automony with regard to the network medium. However, it also goes without saying that at least one functional group can be designed to couple the network system to a further network system, for instance the public electricity network.

It furthermore goes without saying that functional groups designed substantially as “extension” can also be provided. In this case, it is particularly advantageous if such functional groups also provide an extended functionality. This can consist in providing characteristic data which describe cables and/or conductors associated with the functional group. The characteristic data can be accessed by individual network infrastructure components and/or by the network system, for instance. Such characteristic data can comprise, for instance, conductor cross sections, materials for conductors and/or insulation, lengths, thermal stability, chemical resistance or the like. In this way, the network system can acquire, for instance, knowledge of line resistances (resistivities of the conductors) mechanical stability or the like and allow this to influence the control and regulation.

In accordance with a refinement of the network system, at least one network infrastructure component can be coupled at least temporarily to an external monitoring system which allows observation and detection of operating parameters and service data.

A monitoring system can enable monitoring and controlling from outside. The monitoring system can be network-based, for instance, and allow remote access to the network system.

In accordance with a further refinement, the network system furthermore comprises a line system for connecting the coupled network infrastructure components.

It goes without saying that lines can be embodied physically-structurally or else logically-virtually.

In accordance with a refinement of this configuration, the line system comprises a supply network for the network medium and a data network for communication data.

Alternatively, it is conceivable to transmit for instance communication data to the network medium, for example by means of modulation.

In accordance with a refinement, the network system furthermore comprises an auxiliary energy network, in particular an auxiliary voltage network.

Preferably, the network system comprises at least one converter unit between a network infrastructure component and a coupled functional group, in particular a voltage converter.

The converter unit can be embodied, for instance, by a switching controller, a rectifier, inverter, a transformer or the like.

In this way, in particular, network infrastructure components which make different requirements of the network medium can be combined in the network system. This can apply, for instance, to operating voltages of battery units and electrical consumers. In this way, for instance, a consumer, by means of the at least one converter unit, can be supplied by a battery unit which has a different rated voltage that would lead to damage in the event of a direct coupling.

In principle, it is a refinement if the network medium has a substantially constant network voltage, such that consumers and feeders are to be adapted in each case by means of a converter unit.

In accordance with a further refinement, at least one coupled functional group of the network system provides a readable representation of characteristic data which can be fed to the control device of one of the network infrastructure components.

This can involve, for instance, a listing of electrical connection data for individual functional groups, which is stored in each case on the latter.

In a further refinement, the network infrastructure components provide integrated load control for the entire distributed network system.

This can involve, for instance, voltage controlling, current controlling or combined controlling. The integrated load control can relate to the supply level and/or the auxiliary voltage level.

It is a further refinement if each contact unit and each coupling module of each network infrastructure component of the network system can be unambiguously identified.

Furthermore, it is a refinement if the functional groups themselves can also be unambiguously identified, for example by means of identification data stored in the characteristic data.

In accordance with a refinement of the network system, provision is made of a plurality of supply levels embodied by different supply lines, in particular a combination of lines for electrical energy and lines for thermal energy.

The generation of electrical energy is often accompanied by the generation of thermal energy. Consequently, both energy forms can be distributed by the network system in a demand-conforming manner.

Alternatively, it is conceivable to implement a supply level as coolant level, for example in order to operate consumers, energy stores or other components of the network system in a temperature range in which a high efficiency is obtained. Against this background too, it may be recommendable to provide thermal sensors in the case of the network infrastructure components.

In accordance with a further refinement, in the case of the network system, a plurality of functional groups are provided, which are coupled to a network infrastructure component and which are designed as rechargeable energy stores, wherein the network system provides store management.

In this regard, for instance, measures are conceivable for loading the energy stores as uniformly as possible. By way of example, it is possible, even in the case of a plurality of energy stores, to strive for a similar or identical state of charge or state of discharge in each case. The network system allows different energy stores to be coupled which differ, for instance, with regard to their characteristic data and/or with regard to their lifetime-governed performance. A combination of monitoring and active driving makes it possible to provide maximum power even in the case of an heterogeneous network of energy stores.

Particular preference is given to the use of a network system according to any of the above aspects for the drive of a vehicle with an at least partly electrical drive.

Furthermore, the use of one of the network systems mentioned as supply system for regenerative energies is advantageous.

In this way, the entire supply chain, comprising generation, storage, provision, distribution and consumption, can be supervised and controlled by means of an integrated control.

The use of one of the network systems mentioned for operating network-independent electric tools is additionally recommendable. It goes without saying that a substantially autonomous supply of electric devices of any arbitrary type can also be effected.

A further advantageous use of one of the network systems mentioned may consist in the use as buffer store for foreign networks.

Particularly if converter units are provided which, for instance, can convert a given foreign network voltage characteristic into a system-internal voltage characteristic, the network system can be used universally. In particular, it is not necessary to adapt system components, for instance individual network infrastructure components or functional groups (such as energy stores, for instance), to the respective foreign network in a targeted manner. A high compatibility can be ensured. The use as buffer store can smooth load spikes in the network and contribute to improving the supply reliability. In this regard, the buffer capacity can be used to draw or feed energy from or into the foreign network depending on price and demand fluctuations.

In addition, the use of one of the network systems mentioned as change station for exchanging energy stores is also highly advantageous.

The network system is scalable with wide limits. The capability for self-configuration allows “intelligent” management of energy stores. The network system can detect coupled energy stores and charge and/or discharge them in a targeted manner. Consequently, for instance, discharged energy stores can be coupled to arbitrary interfaces (coupling modules). A charging process can be carried out in a rule-based manner and/or in a hierarchy-based manner and, for instance, charge specific energy stores with preference or with lower priority. Consequently, energy stores that have been charged in a prioritized manner in a short time can be offered to a user for further use.

It goes without saying that the features of the invention mentioned above and those yet to be explained below can be used not only in the combination respectively indicated, but also in other combinations or by themselves, without departing from the scope of the present invention.

### BRIEF DESCRIPTION OF THE SEVERAL VIEWS OF THE DRAWING

Further features and advantages of the invention will become apparent from the following description of a plurality of preferred exemplary embodiments with reference to the drawings, in which:

FIG. 1 shows a simplified schematic partial illustration of a network system comprising a plurality of network infrastructure components;

FIGS. 2a-2c show greatly simplified illustrations of different topologies of network systems;

FIG. 3 shows a further simplified schematic partial illustration of a network system;

FIGS. 4a-4c show simplified basic illustrations of different configurations of a network infrastructure component;

FIG. 5 shows a simplified schematic illustration of a network system for supply purposes;

FIG. 6 shows a simplified schematic illustration of a further network system for supply purposes;

FIG. 7 shows a schematic illustration of a network infrastructure component;

FIG. 8 shows a greatly simplified schematic view of a functional group coupled to a network infrastructure component with a converter unit;

FIG. 9 shows a greatly simplified view of two network infrastructure components linked to one another;

FIGS. 10a, 10b show diagrams concerning operating parameters of the network system;

FIG. 11a shows a simplified schematic illustration of network infrastructure components which are coupled to one another and to which a functional group is in each case coupled;

FIGS. 11b, 11c show simplified diagrams with possible time profiles of charging and discharging processes;

FIGS. 12a, 12c show simplified diagrams with time profiles of a characteristic loading and the division thereof among a plurality of storage elements; and

FIG. 12b shows operating data blocks of energy stores whose characteristic is illustrated diagrammatically in FIGS. 12a and 12c.

### DETAILED DESCRIPTION OF THE INVENTION

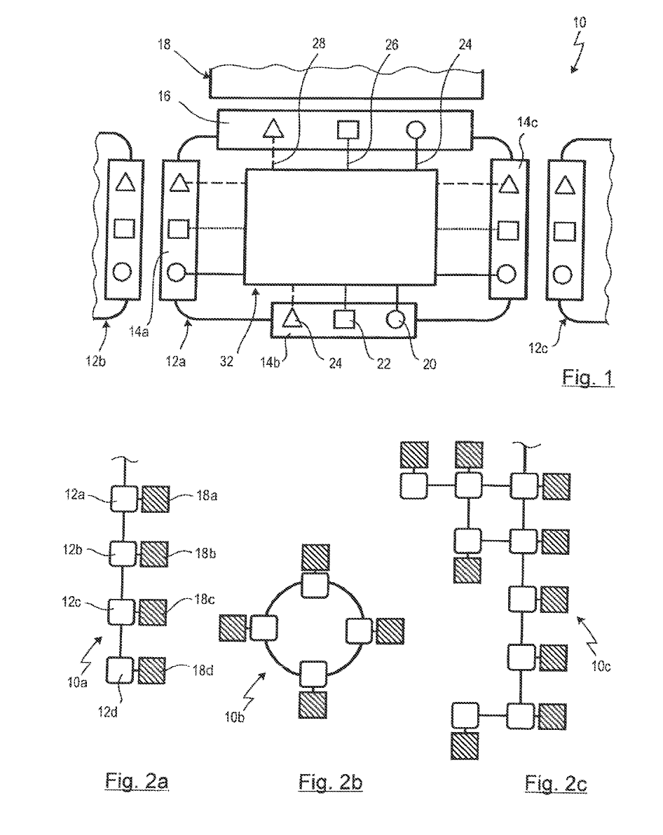

FIG. 1 shows a simplified schematic illustration of a network system 10 comprising a coupling of a plurality of network infrastructure components 12. The network infrastructure component 12a is illustrated schematically; network infrastructure components 12b and 12c coupled thereto are depicted in each case only partially as excerpts. The network infrastructure component 12a comprises a plurality of contact units 14a, 14b, 14c. Each of the contact units 14a, 14b, 14c is designed to couple the network infrastructure component 12a to a further network infrastructure component 12. The coupling can be effected directly by means of plug connectors, for instance. It is likewise conceivable to provide line connectors or the like, particularly if spatial distances are to be overcome when linking a plurality of network infrastructure components 12. It is particularly advantageous if lines, cables or the like are “known” in the network system 10, for instance in order to acquire knowledge about their resistivities or other characteristic data. The contact unit 14b in FIG. 1 is currently not allocated.

It goes without saying that the network infrastructure components 12 (also designated as nodes) can be structured and defined in a structural and/or logical manner. In this regard, the network infrastructure components 12 can be designed for example as plugin modules having defined dimensions which have different contact-connections for linking, comparable for instance to so-called multiway plug sockets or distribution boxes.

However, it is also conceivable, when defining the network infrastructure components 12, for instance also to include lines, cable connections or the like, such that a larger geometrical extent, can result overall. It goes without saying, however, that the network infrastructure components 12 can substantially be characterized by their functional structural components and the provision of a certain functionality. In this respect, consideration should not be given restrictively only to an external design of the network infrastructure components 12. In particular the at least one contact unit 14 and the at least one coupling module 16 of a network infrastructure component 12 can be at a spatial distance from one another and can be connected by means of lines which are likewise assigned to the network infrastructure component 12. This is made possible by virtue of the fact that a defined communication between the elements can take place at various defined levels (supply level, data level, auxiliary voltage level; explained in greater detail below).

The network infrastructure component 12 in accordance with FIG. 1 furthermore comprises a coupling module 16, to which a functional group 18 is coupled. The functional group 18 is merely indicated in sectional illustration. It goes without saying that one or a plurality of coupling modules 16 can be provided in the case of the network infrastructure component 12.

By way of example, the network infrastructure component 12a is designed to communicate at a supply level 20, a data level 22 and optionally at an auxiliary voltage level 24. This can be done, for instance, with the inclusion of supply lines 26, data lines 28 and optionally auxiliary voltage lines 30. The levels 20, 22 and 24 are illustrated here by simplified symbols (circle, rectangle, triangle).

Furthermore, the network infrastructure component 12a can comprise a control device 32, which can realize integrated controlling and control, in particular load control, at least at the supply level 20.

With a plurality of network infrastructure components 12 it is possible to realize network systems 10 which can be operated robustly, in a flexibly extendable manner and in a self-controlling manner and stably with high functional reliability. Such a network system 10 is suitable for mobile applications, in particular, since a connection to stationary supply networks is not necessarily required.

The functional groups 18 can be, for instance, energy stores, electricity generators, consumers and the like. These, respectively coupled to a network infrastructure component 12, can in principle be arranged and distributed arbitrarily in the network system 10.

It is particularly preferred if the network system 10 provides electrical energy and, in particular, the supply network is designed as a direct-current network. In this context, it is recommendable to realize load control in the network system 10 by means of the control device 32, for instance. The load control can be configured as voltage controlling, for instance. The load control can be effected for instance at the level of individual network infrastructure components 12, but also at the level of the entire network system 10.

The combination of the supply level 20 with the data level 22 allows not only an actual network medium (for example electrical energy), but also information to be transported and distributed in order to provide extended functionalities. This can involve, for instance, measures for checking the compatibility of coupled functional groups 18 and comparing the characteristic data thereof with a performance provided by the network system 10. It is thus possible to ensure, for instance, that the functional group 18 can be safely connected to the network system 10. By way of example, it is possible to prescribe that the functional group 18 is linked to the supply level 20 only after checking and adjustment have been carried out.

It is particularly advantageous that such a network system 10 can configure itself automatically even in conjunction with a given high design freedom and can determine, in particular, all interconnected network infrastructure components 12 and functional groups 18 in order to be able to determine a present system architecture (topology) together with given boundary conditions and required operating parameters for instance for controlling and control purposes. This can be done without a superordinate rigid supervisory and controlling structure that would normally necessitate operator interventions for configuration purposes.

In contrast thereto, the network system 10 can also be operated as a so-called plug-and-play system. That is to say that new network infrastructure components 12 and/or new functional groups 18 can be added to an existing network system 10 without relatively high outlay. The new components can be automatically identified and incorporated.

FIGS. 2a, 2b and 2c illustrate by way of example different topologies of network systems 10a, 10b, 10c, comprising in each case intermeshed network infrastructure components 12 and functional groups 18 coupled thereto.

FIG. 2a shows a linearly constructed topology, also designated as serial topology. FIG. 2b illustrates a ring topology. Finally, FIG. 2c shows a mixed topology having combined ring and bus structures. For illustration reasons, an explicit designation of individual network infrastructure components 12 and individual functional groups 18 has been dispensed with in FIGS. 2b and 2c. As indicated by break lines in FIGS. 2a and 2c, for instance, the topologies can readily also be part of larger structures. Further topologies are conceivable, for instance also a star topology.

Each network infrastructure component 12 can be regarded, for instance, as a node or as a router. The combination of the supply level 20 with at least the data level 22 makes it possible to detect or to “map” the structure of the supply level 20 at least indirectly by means of the data level 22. Characteristic data and identification data can be detected for instance in so-called routing tables which correspond to specifications conforming to routing protocols. Consequently, both at the level of the individual network infrastructure components 12 and at the (superordinate) level of the entire network system 10, routing functionality can be provided, that is to say for instance controlled conduction and branching of electrical energy, for example.

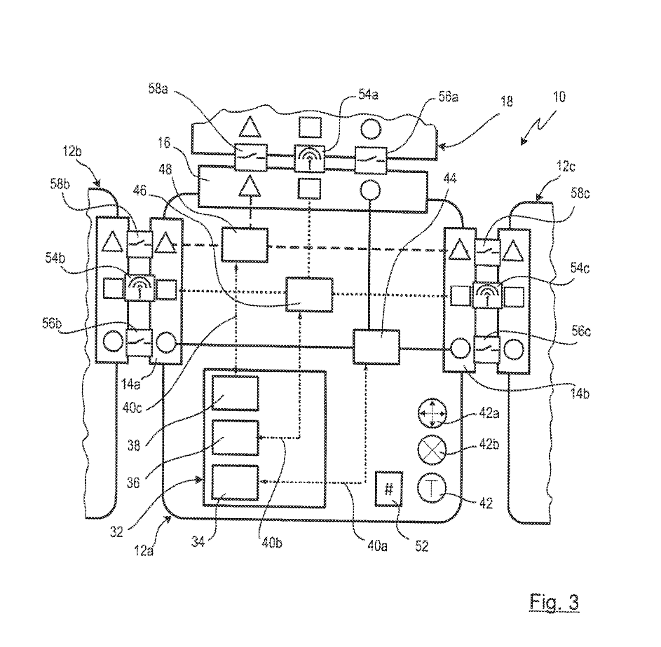

FIG. 3 shows an excerpt from a network system 10 which is similar to the illustration in FIG. 1 and in which a network infrastructure component 12a is illustrated schematically. The network infrastructure component 12a is coupled to a further network infrastructure component 12b by means of a contact unit 14a and to a further network infrastructure component 12c by means of a contact unit 14b. It goes without saying that the network infrastructure components 12c, 12b can be configured similarly or identically to the network infrastructure component 12a. The network infrastructure component 12a is furthermore linked to a functional group 18 by means of a coupling module 16. It goes without saying that a plurality of coupling modules 16 can also be provided in the case of the network infrastructure component 12a.

By way of example, the control device 32 of the network infrastructure component 12a comprises different control units 34, 36, 38. The control unit 34 can be configured for monitoring, controlling and/or regulating a supply network 44 arising at the supply level 20. The control unit 36 can be designed to monitor, control and/or regulate a data network 46 arising at the data level 22. The control unit 38 can be designed to monitor, control and/or regulate an auxiliary voltage network 48 arising at the (optional) auxiliary voltage level 24. It goes without saying that the control units 34, 36 and 38 can be implemented by discrete, integrated or even by the same components of the control device 32. By means of specific control lines 40a, 40b, 40c, the control device can selectively access or intervene in the supply network 44, the data network 46 and/or the auxiliary voltage network 48.

The control lines 32 can be integrated at least partly into the construction of the at least one contact unit 14 and/or of the at least one coupling module 16. A data storage unit for storing data can furthermore be provided in the case of the network infrastructure components 12. The data storage unit can be associated with or else coupled to the control device 32. By means of the data storage unit, for instance a present configuration of the network unit 10 can be saved, for instance in order to simplify start-ups (again) from an off state.

The network infrastructure component 12a furthermore comprises various sensor elements 42 which can serve for detecting further operating parameters, for example ambient conditions. In this regard, an acceleration sensor 42a can be provided, for instance, which is designed to identify spasmodic or jerky loads. Such loads can indicate, for instance, mechanical damage, for example falls, accidents or the like. Such a sensor signal can be used to make selective interventions in the network system 10 in the case of a potential hazard. This can involve, for instance, targeted disconnection or “discarding” of functional groups 18.

The sensor elements 42a, 42b, 42c can be arranged in conjunction with the at least one contact unit 14 and/or in conjunction with the at least one coupling module 16. An integrated design is conceivable. In this way, coupled network infrastructure components 12 and/or functional groups 18 can also be taken into account in the value detection.

A further sensor element 42b can be configured as a light-sensitive sensor, for instance. A wide variety of functionalities can be realized by means of the sensor element 42b. By way of example, these can include smoke detection or fire detection, an occupied-or-free identification, but also alternatively a light intensity measurement, for instance, in particular in the network comprising functional groups designed as solar cells. Various further applications are conceivable.

A further sensor element 42c can be designed as a temperature sensor, for instance. A temperature sensor can determine ambient temperatures, for example, and this can be advantageous particularly in the case of electrical storage units which are operated under fluctuating environmental conditions, in order to be able to determine an instantaneous performance. Other possibilities for use are conceivable, for example the monitoring of electrical components, for instance of the control device 32, or of components of the coupled functional group 18.

Furthermore, the network infrastructure component 12a comprises an identification unit 52, which allows the network infrastructure component 12a itself, but also each of its contact units 14a, 14b and/or each coupling module 16, to be unambiguously identified. It is particularly advantageous if, even in the case of a multiplicity of network infrastructure components 12 coupled to one another, each partial element is unambiguously identifiable and addressable. Detection errors and allocation errors in the control and load control can be avoided in this way.

Each network infrastructure component 12 can be identified by means of an unambiguous identification sequence, independently of whether the position of said network infrastructure component in the network system 10 changes or whether further components are added to the system. On the basis of the identification data, for instance, supply paths, for example current paths, data paths and the like, can be identified and made known to the integrated control of the network system 10.

A contact unit 14 of the network infrastructure component 12 can embody as it were a network-internal link (also: contact point). The at least one contact unit 14 can be designed to conduct the network medium in the supply network 44, data in the data network 46 and auxiliary voltage in the auxiliary voltage network 48 in a defined manner. This can be carried out into the respective network infrastructure component 12 and/or proceeding from the network infrastructure component 12 toward the outside. The contact unit 14 can function as an interface.

The extended functionality of the network system 10 can lead to a certain energy demand upon activation. The auxiliary voltage network 48 can serve, for instance, to provide a basic supply or an initial energy supply in order to be able to “run up” the network system. Alternatively, there is the possibility, in the case of one or more of the network infrastructure components 12, of providing an auxiliary energy store, for example a battery, in order to provide auxiliary energy. Alternatively, a (physical) auxiliary voltage network 48 can be realized with associated auxiliary voltage lines 30. The auxiliary voltage network 48 can be designed for instance for low voltages, for example approximately 5 V, 12 V or the like, and overall low powers. The auxiliary voltage network 48 can be designed for a drawn current of approximately 1 A.

The data network 46 essentially serves to exchange information between components involved, for instance between network infrastructure components 12 coupled to one another indirectly or directly, in order to create and provide an information basis for the control or regulation of the network system 10. The data can be, for instance, operating characteristic data, operating parameters, routing data or protocol data, rules, regulations, rights, limit values, selection possibilities, identification data, and the like, which can be assigned to the present network infrastructure component 12, for instance, but can also be assigned to adjacent network infrastructure components 12 or coupled functional groups 18. The unambiguous identification avoids incorrect assignments and can contribute to structuring data streams.

The supply network 44, for instance also designated as main voltage network, can be embodied, in principle, as an electrical distributor, comparable for instance to known domestic installations and distribution systems for network voltage, for instance for known 230 V AC (alternating current) network voltage.

A coupling module 16 (for instance also designated as gateway) is accorded the task of providing an unambiguous transition to functional groups 18. The coupling module 16 can furthermore be designed to conduct an auxiliary voltage, to provide a data connection, and in particular to exchange the network medium in the supply network between the network infrastructure component 12 and the functional group 18. The coupling module 16 can furthermore be designed to realize adaptation, limitation and controlling of media to be transmitted, in particular at the supply level 20 and the data level 22.

The coupling module 16 can provide an unambiguous, likewise unambiguously identifiable, transition to energy consumers, generators, stores and to further power and data networks. This can be effected by means of a standardized plug system, for instance. Flow rates, that is to say, for instance, current drawn or fed in, can be continuously recorded.

The at least one coupling module 16 can furthermore be designed to provide data transmission toward the outside, that is to say for instance to link the data network 46 to superordinate hierarchies, for instance servers, network applications, or the like, by means of network-based or wireless technologies.

In the context of the connection of individual network infrastructure components 12 in the network and the linking of functional groups 18 to said network infrastructure components, in particular given a parallel structure of the supply network 44 and of the data network 46 (and, if appropriate, of the auxiliary voltage network 48), every connected neighbor of each network infrastructure component 12 (that is to say, for instance, further network infrastructure components 12 and/or further functional groups 18) can be determined indirectly or directly.

FIG. 3 furthermore illustrates by way of example that provision can be made of interfaces 54, 56, 58 for the coupling and communication of the network infrastructure component 12a to and with each neighbor. By way of example, the interfaces 54a, 54b, 54c can be data interfaces assigned to the data network 46. The data interfaces 54a, 54b, 54c can be realized in a wired or wireless manner, for instance. In accordance with one preferred embodiment, RFID-based data interfaces 54a, 54b, 54c are used for communication at the data level 22 between at least two network infrastructure components 12. RFID technology also allows, for instance, passive transponders to be used and, therefore, data to be exchanged with network infrastructure components 12 which (at least at times) have no dedicated power supply. At least an interrogation of characteristic data and fixed operating parameters can be effected by means of passive RFID transponders.

By way of example, each of the network infrastructure components 12 can be designed for bidirectional RFID communication. That means that a network infrastructure component 12, for instance in conjunction with a contact unit 14 or in conjunction with a coupling module 16, can be designed both for passive (transponder) and for active (reader) data interrogation. Depending on its position in the network system 10, the network infrastructure component 12 can therefore provide data for read-out even in the case of a power supply not yet having been established (for instance at the auxiliary voltage level 48).

It is particularly preferred if the functional groups 18 are provided with provisions of characteristic data realized by means of RFID technology, for instance. This makes it possible, before the actual linking at the supply level 20, to interrogate operating parameters and characteristic data and, if appropriate, to decide whether the established network system 10 can “cope” in terms of power with the functional group 18 that is to be newly added. For instance, charging currents/discharging currents or the like can be adapted depending on that. It is likewise conceivable for the functional group 18 that is to be added to be linked only after testing and release at the supply level 20. This can be carried out by means of a hardware switch and/or a software switch, for instance.

A wide variety of, in particular administrative, functionalities in the context of the network infrastructure component 12 can be realized by means of the control device 32. In terms of data, in the control device 32, it is possible to generate and store for instance so-called routing tables (protocol or conduction tables) for connections in the supply network 44, in the data network 46 and/or in the auxiliary voltage network 48. Furthermore, the control device 32 can be designed to provide a so-called data gateway for the data network 46. This can comprise, for instance, protocol-based data lines and data distributions; the data exchange can take place at least with a further network infrastructure component 12 or with a coupled functional group 18, but in particular can also extend to the entire network system 10. Besides the substantially digitally conditioned data at the data level 22, operational functional parameters can furthermore be detected. The latter can concern, for instance, physical measurement values, operating modes, operation possibilities, limit values, summation values and the like relating to variables such as current, voltage, frequency, internal resistance of components involved, temperature, power, energy conversion and the like.

FIG. 3 furthermore illustrates various interfaces 56 through switching elements 56a, 56b, 56c for the supply level 20 at which the supply network 44 extends. The switching elements 56a, 56b, 56c can be designed as hardware switches or as software switches, for instance. The switching elements 56a, 56b, 56c can be activated and/or deactivated for instance by switching pulses provided by the control device 32. This means that, for instance, even if further network infrastructure components 12 or further functional groups 18 have already been (physically) plugged onto the network infrastructure component 12, a galvanic isolation can still be realized by means of the switching elements 56a, 56b, 56c in order to avoid potential damage, for instance in the case of overloads.

The switching elements 56a, 56b, 56c can be configured in a similar manner at the auxiliary voltage level 24. Hardware switches and/or software switches can be involved in this case as well.

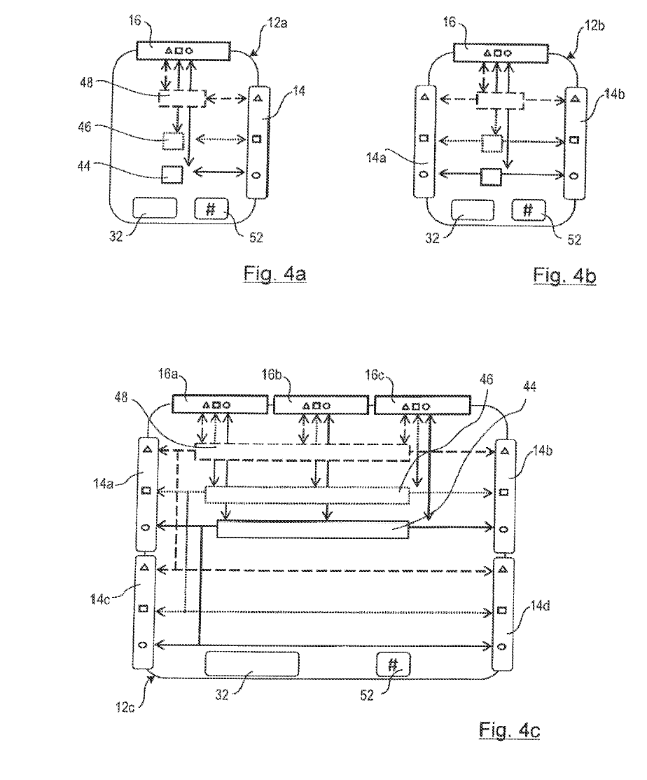

FIGS. 4a, 4b, 4c illustrate three different configurations of network infrastructure components 12a, 12b, 12c which, in terms of their basic function, can correspond or can be at least similar to the abovementioned network infrastructure components 12 described in connection with FIGS. 1 and 3. Each of the network infrastructure components 12a, 12b, 12c comprises a control device 32 and an identification unit 52. However, the network infrastructure components 12a, 12b, 12c differ with regard to the number of contact units 14 and/or coupling modules 16 realized.

By way of example, the network infrastructure component 12a in FIG. 4a is provided with in each case one contact unit 14 and one coupling module 16. By contrast, the network infrastructure component 12b in accordance with FIG. 4b comprises one coupling module 16 and two contact units 14a, 14b. The network infrastructure component 12c is extended further and provided for example with three coupling modules 16a, 16b, 16c and four contact units 14a, 14b, 14c, 14d.

It goes without saying that further designs are conceivable. In particular, it is also conceivable for the network infrastructure components 12 to be extendable modularly, for instance. In this way, the required functionality and number of interfaces could be realized for instance by defined linking of the necessary components, for instance of the control device 32, of the identification unit 52 and of a desired number of the contact units 14 and/or of the coupling modules 16.

As is evident from FIG. 4c, for instance, the respective contact locations of the supply network 44, of the data network 46 and of the auxiliary voltage network 48 of each of the contact units 14 are connected to all contact locations of the respective network level with all other contact units 14 and coupling modules 16. It goes without saying that the control device 32 can selectively intervene in this connection in order to be able to perform connecting, disconnecting and/or controlling processes.

In accordance with one preferred embodiment, the supply network 44 can be operated for instance with DC (direct current) voltage, in particular with a DC voltage of approximately 48 V. In order to be able to ensure the stability of the supply network 44, it is recommendable to use for instance voltage controlling designed, for example, to be able to maintain the voltage on the basis of the reference voltage, for instance 48 V, at least in a fluctuation range. The fluctuation range can comprise for instance ±10%, preferably ±5%.

By way of example, it is conceivable to provide a (global) control range having corresponding characteristic values for the entire network system 10. However, (localized) controlling at the level of individual network infrastructure components 12 can likewise also be provided.

Defined controlling or setting of the voltage present at components involved can bring about an energy transfer, for instance for charging purposes, consumption purposes and/or rearrangement purposes. A current direction can result from a potential difference between coupled functional groups 18. This defines, for instance, whether a battery unit is intended to be charged or discharged. If a plurality of battery units are present, for instance, it is possible to use different setpoint voltage levels to prioritize which battery unit shall be the first to be charged or discharged.

Load control can also comprise current controlling, in particular with current limiting and/or variation of an internal resistance, in particular for current-dependent voltage reduction.

In accordance with a further embodiment, converter units can be interposed for coupling the functional groups 18 to the network infrastructure components 12 of the network system 10, said converter units being designed, for instance, to carry out voltage conversion. In this way, for instance, functional groups 18 which require AC voltage can be connected to a DC power supply network. It is likewise conceivable for functional groups 18 based on direct current to be coupled to the network system 10 by means of a converter unit. This may be the case, for instance, if the functional groups 18 require a different voltage level, that is to say for instance deviating from a rated voltage of 48 V, for example.

This measure has the advantage that a wide variety of energy stores, energy generators and energy consumers can be coupled to one another via the network system 10. In this regard, it is conceivable, for example, for various battery units whose characteristic data differ with regard to the voltage level, in particular, to be linked via the network system 10 in order to be able to utilize their total energy or total capacity.

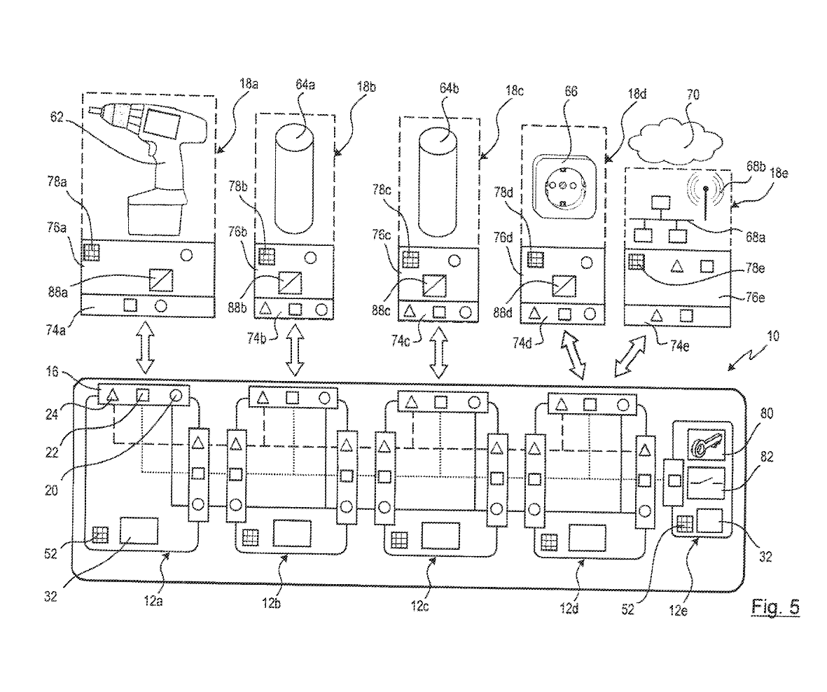

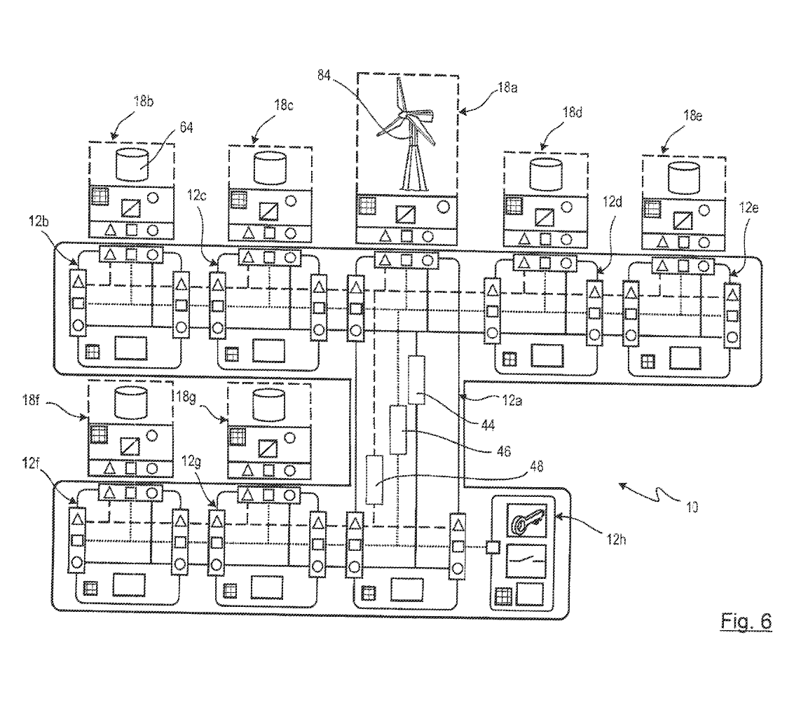

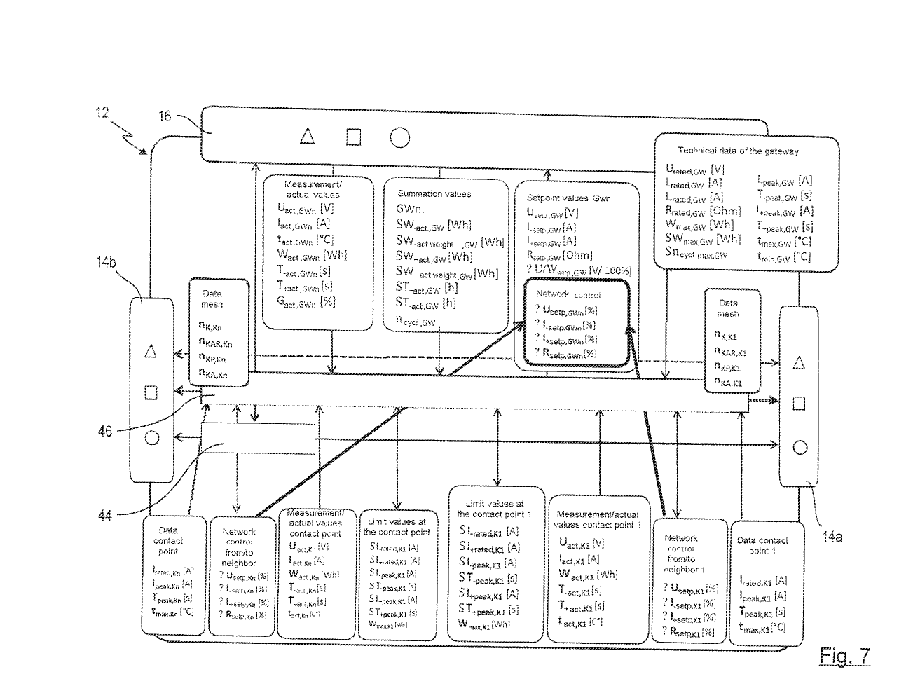

Possible configurations of network systems 10 are illustrated schematically in FIGS. 5 and 6.

FIG. 5 shows an application in which the network system 10 is primarily used to drive a network-independent electric tool 62 by means of energy stores 64. By contrast, the exemplary embodiment in accordance with FIG. 6 shows an interconnection of an energy generator in the form of a wind turbine 84 with a plurality of energy stores 64.

In the case of the network system 10 in accordance with FIG. 5, a plurality of functional groups 18 are linked to one another by means of a plurality of network infrastructure components 12. The functional group 18a can be embodied by an electric tool 62, for example. Such electric tools 62, for example so-called cordless screwdrivers or cordless drills, are known in the prior art. The requirement for a proprietary energy storage system is often disadvantageous in the case of such devices. A rated voltage of known energy storage systems can be approximately 36 V. For illustration reasons, in FIG. 5, network infrastructure components 12 and functional groups 18 coupled to one another are illustrated as linked to one another abstractly by means of block arrows. It goes without saying that the coupling can be, in principle, of logical and/or discrete-structural type. In particular, it is not absolutely necessary for each coupling between a network infrastructure component 12 and a functional group 18 to be (arbitrarily) releasable.

In the case of the network system 10 in accordance with FIG. 5, the (energy) storage management is effected by the network infrastructure components 12a, 12b, 12c, 12d and 12e coupled to one another. A first functional group 18a, to which the electric tool 62 is assigned, is linked to the network infrastructure component 12a. A further functional group 18b, to which an energy store 64a is assigned, is linked to the network infrastructure component 12b. Yet another functional group 18c, to which an energy store 64b is assigned, is linked to the network infrastructure component 12c.

By contrast, the network infrastructure component 12d is coupled to two functional groups 18d, 18e. By way of example, the functional group 18d has a contact with an energy source 66, for instance with a conventional domestic network connection. Such a network connection 66 can provide energy, for instance for feeding the supply network 44. No further functionality can regularly be provided over and above that. By contrast, the functional group 18e is primarily oriented toward enabling data connections to superordinate entities, for instance a network-based monitoring system 70. For this purpose, the functional group 18e can provide alternatively or in parallel, for instance, a line-based communication link 68a or a wireless communication link 68b. This can involve known network technologies, in principle, for example LAN technologies or WLAN technologies.

On the part of the functional groups, a respective coupling unit 74a, 74b, 74c, 74d, 74e can be assigned to the respective coupling modules 16 (cf. FIG. 1 and FIG. 3, for instance) of the network infrastructure components 12a to 12d. The coupling unit 74a can be configured as a plug, for instance. Depending on the functionality or device requirement on the part of the functional groups 18, the coupling units 74 can be designed, for instance, to communicate with the network infrastructure components 12 both at the supply level 20, the data level 22 and at the auxiliary voltage level 24. However, it may also be possible for communication to take place at only one or two of the levels 20, 22, 24. In this regard, by way of example, the coupling unit 74a is designed to establish connections at the data level 22 and the supply level 20. This can be attributed, for instance, to the fact that the electric tool 62 to be coupled is not designed to be addressed by means of an auxiliary voltage at the auxiliary voltage level 24.

For the network system 10 or the network infrastructure component 12a coupled directly to the functional group 18a, information referring to this circumstance can be stored in characteristic data 78a, for instance, which are stored at an internal functional level 76a of the functional group 18a. Such characteristic data can comprise identification data, operating parameters, minimum and maximum values and the like. The characteristic data 78a can be interrogated for instance by the control device 32 of the network infrastructure component 12a via the data level 22. In this way, the control device 32 can discover what type of functional group 18a is coupled and/or is intended to be coupled. In the same way, for instance, the functional groups 18b, 18c comprising the energy stores 64a, 64b can also keep characteristic data 78b, 78c at internal functional levels 76b, 76c, which characteristic data can be interrogated and evaluated by the network infrastructure components 12b, 12c or alternatively by the network system 10 overall.

As indicated in the case of the coupling units 74b, 74c, contact can be made with the energy stores 64a, 64b at all three levels, the supply level 20, the data level 22 and the auxiliary voltage level 24. In this way, each of the energy stores 64a, 64b can provide an auxiliary voltage, for instance, which can be distributed via the auxiliary voltage network 48 in the network system 10. By means of the auxiliary voltage, by way of example, the control devices 32 of the network infrastructure components 12 can be supplied with an operating voltage.

The energy source 66 assigned to the functional group 18d can in principle also provide characteristic data 78d at an internal functional level 76d. This may not be the case for conventional domestic sockets, for instance. However, there are initial approaches for also providing such interfaces to energy sources with characteristic data 78d which can be read out by means of RFID technology, for instance, in order to allow an identification or the read-out of specific operating parameters, for instance.

The functional group 18e serves primarily for data exchange, in particular for monitoring purposes. For this reason, linking to the functional group 18e at the supply level 20 is not intended. Nevertheless, contact can be made with the functional group 18e at the auxiliary voltage level 24, for instance, in order to supply the communication links 68a, 68b with energy, for instance.

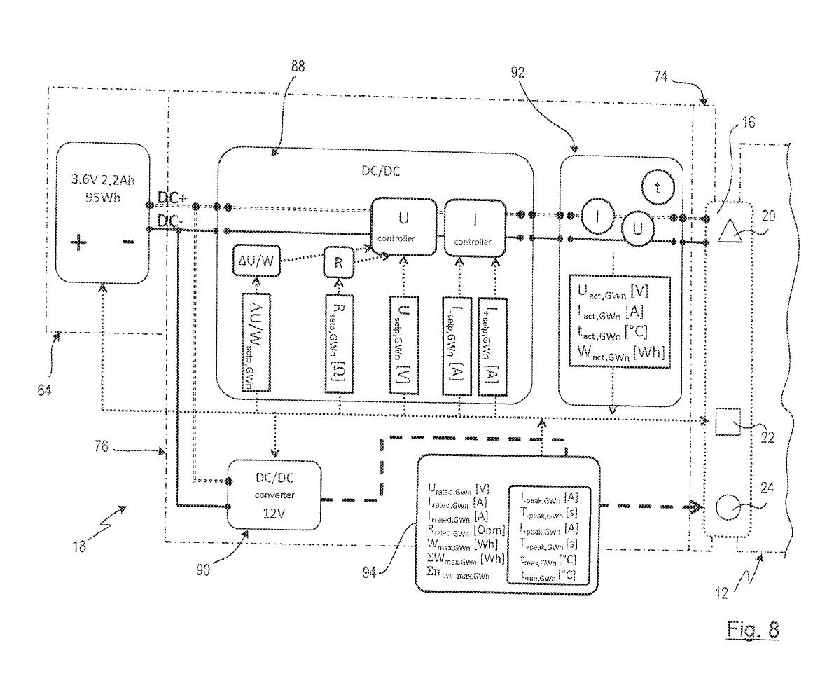

It goes without saying that further devices can be associated with the functional levels 76 of the functional groups 18, in particular converter units 88a, 88b, 88c, 88d for voltage matching. This will be discussed in greater detail below in particular in connection with FIG. 8.

The network system 10 in accordance with FIG. 5 furthermore comprises with the network infrastructure component 12e a unit that serves primarily for access control. For this purpose, besides the control device 32 and the identification unit 52, for instance, the network infrastructure component 12e can furthermore comprise an authentication unit 80 and an access management unit 82.

Consequently, the aim of the network infrastructure component 12e is primarily not the provision of a (primary) network medium at the supply level 20, but rather access control for the network system 10. The authentication unit 80 can comprise a key system or a password system, for instance. It is particularly preferred if the authentication unit 80 comprises a reader, in particular an RFID reader. Such a reader can be designed to read out key data stored on an RFID transponder, for example. The role of a user can be determined on the basis of a key stored on the transponder. Proceeding from this, it is possible for specific roles to be allocated to the user by means of the access management unit 82. In this way, different rights can be assigned to different user groups. It goes without saying that, contrary to the illustration in FIG. 5, by way of example, auxiliary energy can be fed to the network infrastructure component 12e at the auxiliary voltage level 24.

The network system 10 illustrated in FIG. 6 has a construction which is similar, in principle, to the illustration in FIG. 5.

The network system 10 in FIG. 6 serves for linking an energy generator, for instance a wind power installation 84, to a plurality of energy stores 64. The energy generator 84 is assigned to the functional group 18a. The energy stores 64 are assigned to the functional groups 18b, 18c, 18d, 18e, 18f, 18g. The functional groups 18 are linked to one another by the network infrastructure components 12a, 12b, 12c, 12d, 12e, 12f, 12g. The linking can comprise, depending on the functional groups, the supply network 44, the data network 46 and/or the auxiliary voltage network 48. The network infrastructure component 12h, for instance, in a manner similar to the network infrastructure component 12e in FIG. 5, serves primarily for authentication and access management purposes.

It goes without saying that the network system 10 in accordance with FIG. 6 can also have a communication link which can provide a connection to external monitoring systems; in this respect, also cf. FIG. 5.

The modularly constructed network systems 10 illustrated schematically in FIGS. 5 and 6 in each case allow the linking of functional groups that are actually incompatible with one another. In this way, a higher flexibility can arise in particular in the field of generation and storage of regenerative energies or in the field of electromobility and generally in applications with network-independently operating consumers.

It goes without saying that, for instance, the network system in accordance with FIG. 5 is connected to the energy source 66 only temporarily, in particular when the energy stores 64 are to be charged.

Furthermore, it is advantageous if each of the coupling modules 16 of the network infrastructure components 12 linked in the network systems 10 can record and communicate what quantities of electricity have passed through said coupling module. An accounting and reimbursement module, for instance, can be realized in this way.

As already mentioned above, the common realization of the supply level 20 and the data level 22 allows a wide variety of generators, stores and consumers to be linked to one another, without having to fear disadvantages or damage for the network system 10. The communication at the data level 22 allows characteristics of connected functional groups 18 to be determined and, consequently, flow rates, total powers, capacities and the like to be detected and/or anticipated. In this way, different power classes can be covered with just one concept. In particular, such a network system 10 is open to future power adaptations.

In the case of the network system 10 in accordance with FIG. 5, charging of the energy stores 64 can be brought about for instance by means of a converter (cf. converter units 88) interposed between the energy source 66 and the network infrastructure component 12d for instance. The further distribution of the charging current can be realized network-internally by means of the network infrastructure components 12.

It furthermore goes without saying that the electric tool 62 can also be operated in a “network-linked” manner with interposition of the network system 10, if the network infrastructure component 12d is actively coupled to the functional group 18d. In this case, by means of different converter units 88, an (AC) network voltage, for instance, can be converted into a rated voltage for the network system 10 and subsequently into a rated voltage required for the electric tool 62. Furthermore, the energy stores 64 can have a dedicated specific rated voltage, for which corresponding converter units 88 can be provided.

By means of specific voltage controlling provided in the respective network infrastructure components 12, it is possible to control current flows in the entire network system 10. In this way, by way of example, individual energy stores 64 can be charged and/or discharged with high or low priority. This can afford various advantages in practice. Thus for instance if the network system 10 serves as rechargeable battery charging station, for example, wherein charged energy stores 64 can be supplied for external use. In such applications, targeted prioritization can make it possible that only filled energy stores 64 are ever exchanged.

As already mentioned above, the coupling modules 16 of the network infrastructure components 12 can be designed to detect various data. This can involve, for instance, a selection from the following possible physical values presented in table 1:

| Coupling module | Coupling | Setpoint | Actual | Summation |
|---|---|---|---|---|
| (gateway) contin- | module | control- | measurement | values |
| uous loading | (gateway) peak | ling value | value coupling | coupling |
| capability | limit | adjustable | module (gateway) | module (gateway) |
| U_{rated, GWn} [V] | I_{-peak, GWn} [A] | U_{setp, GWn} [V] | U_{act, GWn} [V] | ΣW_{-act, GWn} [Wh] |
| Rated voltage | T_{-peak, GWn} [s] | Setpoint voltage | Present voltage at | Summation |
| I_{-rated, GWn} [A] | Max. peak | I_{-setp, GWn} [A] | the network node | meter energy |
| Current drawn by | current during | Max. current | I_{act, GWn} [A] | drawn by the |
| the gateway from | the drawing | drawn by the | Present current | gateway from |
| the network | with time | gateway from the | between gateway | the mesh |
| I_{+rated, GWn} [A] | indication | network | and network. | ΣW_{-act weight, GWn} |
| Current feed from | I_{+peak, GWn} [A] | I_{+setp, GWn} [A] | Positive −> feed | [Wh] |
| the gateway into | T_{+peak, GWn} [s] | Max. current fed | negative −> | Summation |
| the network | Max. peak | from the gateway | drawing | meter energy |
| R_{rated, GWn} [ohms] | current during | into the network | t_{act, GWn} [° C.] | drawn by the |
| Internal resistance | the feed with | R_{setp, GWn} [ohms] | Temperature | gateway |
| W_{max, GWn} [Wh] | time indication | Internal | gateway | weighted |
| Storable energy | t_{max, GWn} [° C.] | resistance | W_{act, GWn} [Wh] | ΣW_{+act, GWn} [Wh] |
| per cycle in the | Temperature | ΔU/W_{setp, GWn} | Presently stored | Summation |
| gateway | maximum | [V/100%] | energy in the | meter energy |
| ΣW_{max, GWn} [Wh] | t_{min, GWn} [° C.] | Voltage differ- | gateway | fed from the |
| Storable energy | Temperature | ence with respect | T_{-act, GWn} [s] | gateway into the |
| over service life in | minimum | to charge filling | Present running | mesh |
| the gateway | | SOC | time until dis- | ΣW_{+act weight, GWn} |
| Σn_{cycl max, GWn} | | | charge of the | [Wh] |
| Number of cycles | | | gateway | Summation |
| over life time | | | T_{+act, GWn} [s] | meter energy |
| | | | Present running | fed by the |
| | | | time until full | gateway |
| | | | charge of the | weighted |
| | | | gateway | ΣT_{+act, GWn} [h] |
| | | | G_{act, GWn} [%] | Operating hours |
| | | | Present weighting | meter charge |
| | | | for weighted | gateway |
| | | | energy | ΣT_{-act, GWn} [h] |
| | | | SOH_{act, GWn} [%] | Operating hours |
| | | | State of health of | meter discharge |
| | | | the gateway | gateway |
| | | | | n_{cycl act, GWn} |
| | | | | Number of |
| | | | | cycles |

In table 1, the term “gateway” denotes a coupling module 16, for example. Terms such as “network” or “mesh” relate, in particular, to the supply network 44. The term “network node” can be equated with a contact unit 14.

The setpoint values shown in table 1 can be used, for instance, as target variables for the load control, wherein, for example, allowed bandwidths can be specified.

Table 2 below shows exemplary physical values which can be used in the construction, operation and in the monitoring and control of the network system 10, of individual network infrastructure components 12 and of individual contact units 14 and/or coupling modules 16.

| | | Setpoint controlling | | |
|---|---|---|---|---|
| | Plug connector | value adjacent | Actual | |
| Network system | loading | network infrastructure | measurement | Summation |
| (mesh) contacts | capability | component (neighboring node) | value | values limits |
| n_{K, Kn} | I_{rated, Kn} [A] | ΔU_{setp, Kn} [A] | U_{act, Kn} [V] | ΣI_{rated, Kn} [A] |
| Number of all | Max. current | Percentage | Present voltage at | Sum of the |
| following nodes | transfer at the | reduction or | the contact point | possible current |
| at the contact | plug connector | increase of the | I_{act, Kn} [A] | drawn from the |
| point K1, K2 . . . Kn | K1, K2 . . . Kn | setpoint | Present current at | contact point at |
| n_{KAR, Kn} | I_{peak, Kn} [A] | voltage of the | K1, K2, K3 . . . Kn | K1, K2 . . . Kn |
| Number of active | T_{peak, Kn} [s] | neighboring node at | Positive −> current | ΣI_{+rated, Kn} [A] |
| and controllable | Max. peak | K1, K2, K3 . . . Kn | flow to the | Sum of the |
| nodes at the | current transfer | ΔI_{-setp, Kn} [%] | neighboring | possible current |
| contact point K1, | at the plug | Percentage | contact point, | fed in the |
| K2 . . . Kn | connector K1, | reduction of the | negative −> | contact point at |
| n_{KP, Kn} | K2 . . . Kn | maximum current | current flow to the | K1, K2 . . . Kn |
| Number of | t_{max, Kn} [° C.] | drawn by the node | own node | ΣI_{-peak, Kn} [A] |
| passive or | Temperature | from the | W_{act, Kn} [Wh] | ΣT_{-peak, Kn} [s] |
| deactivated | maximum at the | neighboring node | Presently stored | Sum of the |
| nodes at the | plug connector | ΔI_{+setp, Kn} [%] | energy at the | possible peak |
| contact point K1, | K1, K2, K3 . . . Kn | Percentage | contact point | current drawn |
| K2 . . . Kn | | reduction of the | T_{-act, Kn} [s] | from the contact |
| n_{KA, Kn} | | maximum current | Present residual | point at K1, |
| Number of active | | fed by the node | time for discharge | K2 . . . Kn |
| nodes at the | | from the neighbor- | at the contact | ΣI_{+peak, Kn} [A] |
| contact point K1, | | ing node | point K1, K2 . . . Kn | ΣT_{+peak, Kn} [s] |
| K2 . . . Kn | | ΔR_{setp, Kn} [%] | T_{+act, Kn} [s] | Sum of the |
| | | Percentage change | Present residual | possible peak |
| | | in the internal | time for charging | current fed into |
| | | resistance of the | at the contact | the contact |
| | | neighboring node | point K1, K2 . . . Kn | point at K1, |
| | | | t_{act, Kn} [° C.] | K2 . . . Kn |
| | | | Temperature at | W_{max, Kn} [Wh] |
| | | | the plug connector | Sum of the |
| | | | K1, K2 . . . Kn | storable energy |
| | | | | at the |
| | | | | contact point |
| | | | | K1, K2 . . . Kn |

In table 2, a node can be regarded as a network infrastructure component 12, for instance. The other conventions can correspond to the conventions already mentioned in connection with table 1. By way of example, relative setpoint value changes can be transferred instead of absolute values at individual contact units 14 between adjacent network infrastructure components 12. Such a representation can contribute to minimizing a required data flow.

During detection and monitoring of all required values, along a current path to be covered, for instance, partial values can be detected, summed and interrogated as necessary. In this way, sufficient knowledge of the entire network system 10 can be present even in the case of individual network infrastructure components 12.

An assignment of the values described in tables 1 and 2 to an exemplary network infrastructure component 12 can be gathered from the schematic illustration in FIG. 7.

FIG. 8 shows an embodiment of a network infrastructure component 12, to which is coupled a functional group 18 having an energy store 64. The functional group 18 furthermore has a coupling unit 74 and a functional level 76. The functional level 76 comprises a converter unit 88 and an auxiliary converter 90. The auxiliary converter 90 can be designed to provide a low voltage for the auxiliary voltage level 24.

By contrast, the converter unit 88 is designed to convert a voltage provided by the energy store 64 into a rated voltage of the supply level 20 of the network infrastructure component 12. For this purpose, for instance, a current controller (I controller) and/or a voltage controller (U controller) can be provided in the case of the converter 88.

The functional level 76 can furthermore have a sensor unit 92, which is designed to detect operating characteristic data, for instance current (I), voltage (U), transmitted power (W), temperatures (T or t) or the like. The sensor unit 92 can communicate via the data level 22 for instance with the network infrastructure component 12, in particular the control device 32 thereof (not illustrated in FIG. 8).

Data communicated at the data level 22 can comprise the variables described by way of example in an operating data block 94. These variables can be fed to the converter unit 88 and/or to the auxiliary converter 90. In this way, in particular, the converter unit 88 can be driven for targeted load control.

The current controller of the converter unit 88 can be designed, for instance, to comply with a positive current limit and a negative current limit. The voltage controller can be designed to set a desired rated voltage. In addition, a controllable internal resistance (R) can be provided in order to further influence the voltage level. Furthermore, a controlling variable based on a ratio between a voltage difference and a present state of charge (AU/W) can be provided in the case of the voltage controller. Such a value can be approximately 2 V/100%. This means, for instance, given an exemplary rated voltage of 48 V, that the voltage is 47 V at 0% charge and 49 V at 100% charge. In this way, all the energy stores (batteries) in the network system, for the same rated voltage, can jointly reach a setpoint charge value and/or setpoint discharge value.

The values determined by means of the sensor unit 92 can for instance also be used to determine a residual capacity of the connected energy store 64 or to detect consumption values, for instance current consumptions or the like.

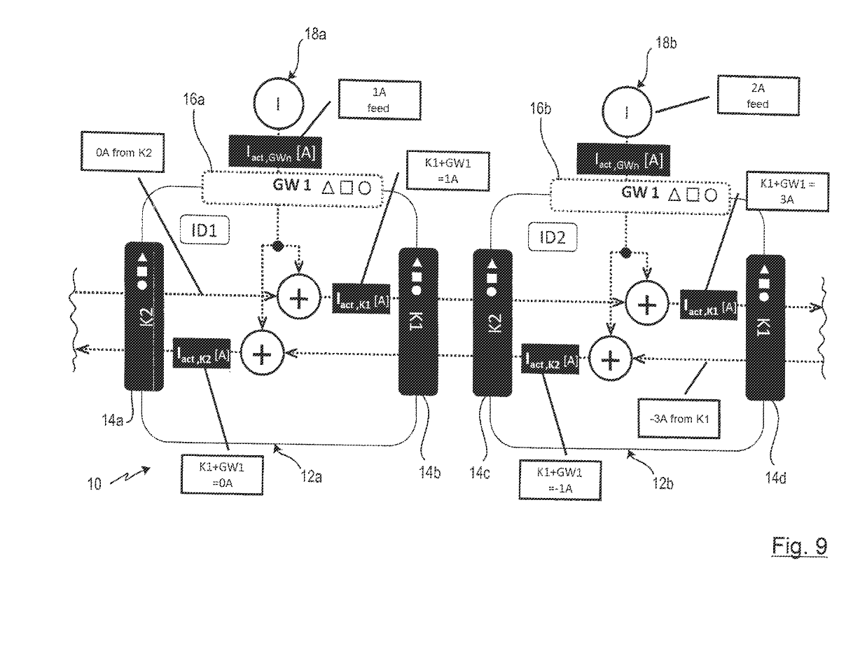

FIG. 9 shows a greatly simplified illustration of two network infrastructure components 12a, 12b of a network system 10 that are coupled to one another. The network infrastructure component 12a is coupled to a functional group 18a. The network infrastructure component 12b is coupled to a functional group 18b. The functional groups 18a, 18b can be energy stores, in particular. Feed values that are fed to the network infrastructure component 12a, for instance, are summed in progress with the feed values that are fed to the network infrastructure component 2b and with possible previous feeds. That is to say that even with ignorance of a next but one network infrastructure component 12, for instance, each of the network infrastructure components 12, by accepting values of its adjacent network infrastructure component 12, can contribute to detecting the overall functionality of the network system 10. Moreover, in the case of such network structures, it is possible to apply Kirchhoff's rules for determining the currents and voltages.

It is therefore not necessary that essential data over and above a neighborhood relationship between two network infrastructure components 12 coupled directly to one another must be transmitted to further network infrastructure components 12. In this way, the volume of data to be transmitted in total can be significantly limited. Nevertheless, a sufficient information basis for control and controlling, in particular load control, of the entire network system 10 can be provided.

Latencies for conducting controlling variables can be comprehended in a simple manner, wherein controlling algorithms can be provided in order to correspondingly take account of and/or compensate for them.

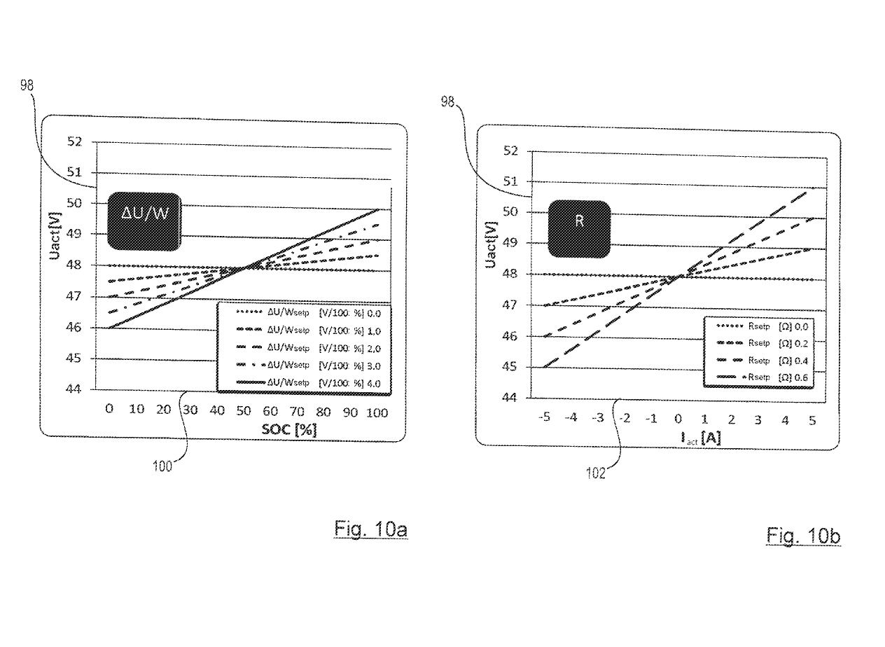

FIG. 10a shows a simplified diagram of an exemplary system illustrating the influence of a controlling variable ΔU/W on a relationship between a voltage U_{act} and a state of charge SOC. In this case, a voltage axis is designated by 98 and a state of charge axis is designated by 100. In FIG. 10a, the ratio ΔU/W is varied in steps.

In a similar manner, FIG. 10b illustrates a relationship between a voltage U_{act} and a current I_{act} depending on a given resistance (internal resistance) Rₛₑₜₚ. In this case, the voltage axis is once again designated by 98, and a current axis by 102. FIGS. 10a and 10b illustrate possible influences on the voltage controlling.

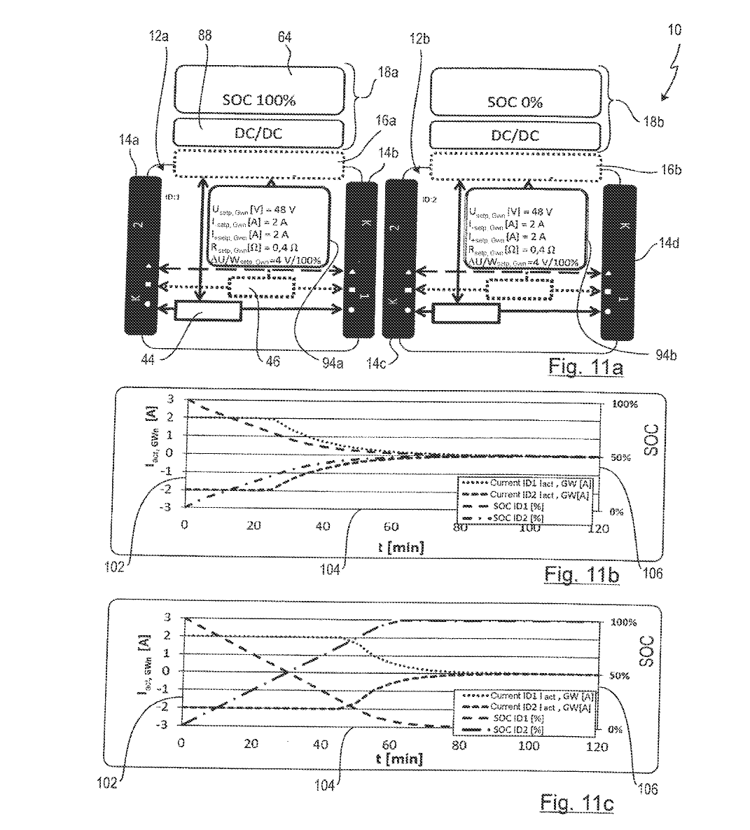

Various adaptation processes in a network system 10 can be illustrated with reference to FIGS. 11a, 11b and 11c. The network system 10 in accordance with FIG. 11a comprises, for example, two network infrastructure components 12a, 12b, which are respectively linked to a functional group 18a, 18b. The functional groups 18a, 18b each have an energy store 64. The energy store assigned to the first network infrastructure component 12a is fully charged in the initial state (SOC=100%). The energy store 64b assigned to the second network infrastructure component 12b is fully discharged in the initial state (SOC=0%).

FIG. 11b illustrates a time sequence of an equalization process between the states of charge of the energy stores 64 in accordance with FIG. 11a. In this case, a current axis I is designated by 102. A time axis is designated by 104. An axis designated by 106 identifies a state of charge SOC of an energy store 64. It becomes clear from FIG. 11b that a (positive and negative) current limiting (±2 A) is provided, also cf. the operating data blocks 94a, 94b in FIG. 11a. Consequently, a reduction of the charging current or discharging current toward an equalization state between the two energy stores 64 is effected only after a specific time.

The illustration in FIG. 11c proceeds, analogously to FIG. 11b, from the same initial state in accordance with FIG. 11a, but a charge reversal is effected here. That is to say that the originally fully charged energy store 64 is fully discharged, and vice-versa. Proceeding from the operating data blocks 94a, 94b in FIG. 11a, the setpoint stipulations can be adapted in order to initiate the charge reversal. In this regard, by way of example, the setpoint voltages can be adapted. The equalization process illustrated in FIG. 11b can be initiated by uniform voltage stipulation (here for instance: Uₛₑₜₚ=48 V for both energy stores 64). The charge reversal in accordance with FIG. 11c can be initiated by different voltage stipulations which discharge one energy store 64 (ID1) in a targeted manner and charge one energy store 64 (ID2) in a targeted manner, without striving for equalization (here: ID1 Uₛₑₜₚ=50 V, ID2 Uₛₑₜₚ=46 V). A current limiting (±2 A) can once again be manifested.

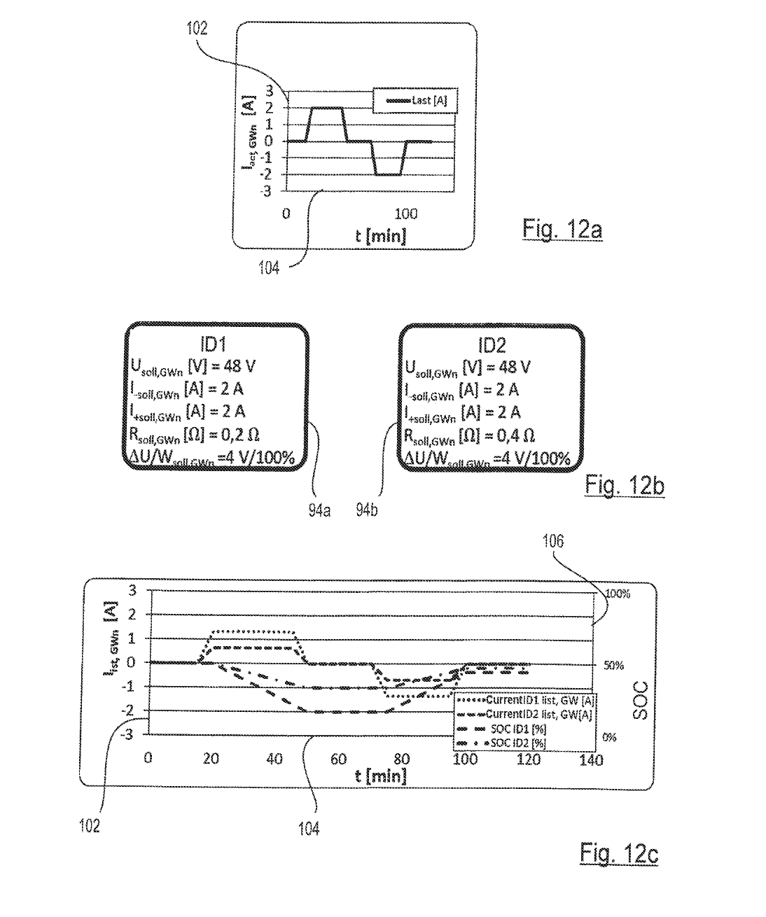

FIG. 12a and FIG. 12c subsequently show diagrams, corresponding to one another in terms of the time sequence, regarding how a current distribution in two energy stores 64, for instance in accordance with FIG. 11a, can arise for a given loading, cf. FIG. 12a. Associated operating parameters can be gathered from the operating data blocks 94a, 94b in FIG. 12b. The cause of the different profiles in FIG. 12c can be seen in the fact that different setpoint internal resistance values Rₛₑₜₚ (in one case 0.2Ω, in one case 0.4Ω) are predefined for the two energy stores 64.

The result evident in FIG. 12c is that the energy store 64 assigned to the network infrastructure component 12a having the lower internal resistance Rₛₑₜₚ takes up and outputs current during loadings (discharges and charges) in an opposite relationship with respect to the relationship of the internal resistances Rₛₑₜₚ between the operating data blocks 94a and 94b.

This illustrates that the characteristic features of different energy stores 64 can be influenced by varying the internal resistance Rₛₑₜₚ. By way of example, in the case of advanced aging of an energy store 64, a smaller current flow can be brought about by choosing a higher internal resistance.

In accordance with a further embodiment, different access rights, in particular role-based access rights, can be allocated for individual or all network infrastructure components 12 of a network system 10. These access rights can relate for instance to the supply level 20, the data level 22 and/or the auxiliary voltage level 24. From the point of view of a network infrastructure component 12, the following roles can occur, for example: adjacent network infrastructure component, guest, manufacturer, service, owner, user, network operator and user group. Further roles are conceivable.

Specific access rights can be granted to said roles, for instance in the following areas: data transmission, coupling module data (gateway data), supply level, supply network, supply level access via coupling modules, (access to) access rights, software update, network values and auxiliary voltage.

Access rights can comprise for instance an indirect access and/or a password- or login-based access. Moreover, the access rights can be used to determine, for instance, whether a role owner is permitted to carry out reading and/or writing, and whether for instance charging and/or discharging are/is permitted, furthermore for instance to the effect of the number of adjacent nodes to which the access rights can extend. In this way, access rights can be managed in tabular form.

By way of example, in the case of the network infrastructure component 12, specific access tables can be stored, for instance for different types of utilization. This can concern for instance selling, renting, leasing, public or private provision and the like and can be related to the network system 12 and/or functional groups 18.

A monitoring system, for instance an Internet-based monitoring system (also cf. FIG. 5), can enable role-dependent generation of data and the provision thereof, including role-based access rights. This can occur to such an extent, for instance, that individual network infrastructure components 12 can be localized by means of network-based applications. Such an online access for monitoring purposes allows a user and/or owner to obtain an overview of capacities, consumptions, powers and/or incurred and/or expected costs.

In this way, by remote monitoring, for instance, it is possible to detect damaged and/or defective functional groups, in particular faulty energy stores 64.

With appropriate scaling, a network system 10 linked to a plurality of functional groups 18 having energy stores 64 by means of a plurality of network infrastructure components 12 can be used for instance for the drive of electric tools, electric bicycles, electric scooters, electric vehicles generally and/or as peak current store or buffer store for installations for regenerative energy production, in particular solar installations and wind power installations. Energy can thus be provided efficiently and in a manner conforming to demand and/or in a manner controlled by availability.

The communication made possible by the data level 22 provided alongside the supply level 20 makes it possible overall to operate the network with less “safety reserve”, since significantly fewer unforeseeable load fluctuations should be expected in comparison with conventional networks.

The system-inherent data exchange makes it possible to fashion networks more efficiently and to work toward a precise, virtually congruent match between provision and requirement of electrical energy.

The open approach contributes to being able to combine a multiplicity of (electrical) energy stores in a system and to make them available for consumers and/or generators. Disadvantages of proprietary solutions can be avoided in this way.

The open and self-configuring structure makes it possible to fashion the network system 10 flexibly and in a manner conforming to the application. Changes and extensions, in particular, can be carried out virtually without additional set-up outlay.

The conception as a distributed system allows large central supply systems affected by significant disadvantages to be replaced by distributed systems in which a multiplicity of small units are coupled to one another, which are fashioned significantly more congenially to the application. Particularly in the case of damage to the energy stores, consequential damage can be reduced or entirely avoided with distributed systems.

Further, the current disclosure comprises embodiments according to the following clauses:

Clause 1. A network infrastructure component comprising the following:

at least one contact unit for connection to a further network infrastructure component, at least one coupling module for coupling a functional group, wherein the network infrastructure component is designed to communicate with a coupled functional group at least at a supply level, wherein the network infrastructure component is designed to communicate with at least one further network infrastructure component at least at the supply level and/or a data level, such that a self-configured network system for linking a plurality of functional groups can be produced with a network of a plurality of network infrastructure components.

Clause 2. The network infrastructure component according to clause 1, furthermore comprising a control device for controlling operating parameters, in particular for load control at the supply level.
Clause 3. The network infrastructure component according to clause 2, wherein the control device is furthermore designed to detect characteristic data of the coupled functional group, in particular at the supply level and/or the data level.
Clause 4. The network infrastructure component according to clause 2 or 3, wherein the control device is designed to take account of operating parameters of at least one further contacted network infrastructure component during the control.
Clause 5. The network infrastructure component according to any of clauses 2 to 4, wherein the control device is designed to communicate detected operating parameters at the data level to at least one further contacted network infrastructure component.
Clause 6. The network infrastructure component according to any of clauses 2 to 5, furthermore comprising at least one sensor element, in particular a temperature sensor and/or an acceleration sensor, wherein the at least one sensor element can be addressed by the control device.
Clause 7. The network infrastructure component according to any of the preceding clauses, which is furthermore designed to communicate with at least one further network infrastructure component and/or the coupled functional group at an auxiliary energy level, in particular an auxiliary voltage level.
Clause 8. The network infrastructure component according to any of the preceding clauses, which comprises an authentication unit for a user, in particular wherein said authentication unit is coupled to the control device.
Clause 9. The network infrastructure component according to any of clauses 2 to 8, wherein the control device provides rule-based access rights for a user.
Clause 10. The network infrastructure component according to any of clauses 2 to 9, wherein the control device is designed to carry out load limiting and/or load disconnection for the coupled functional group.
Clause 11. The network infrastructure component according to any of the preceding clauses, wherein the communication at the data level with the at least one further network infrastructure component and/or the coupled functional group is carried out by means of wireless data transmission, preferably by means of electromagnetic waves, more preferably by means of RFID technology.
Clause 12. The network infrastructure component according to any of the preceding clauses, which furthermore comprises an identification unit, which allows the network infrastructure component and each coupling module and/or each contact unit to be unambiguously identified.
Clause 13. A distributed network system for supply purposes, which is designed for transporting a network medium at a supply level, comprising a plurality of coupled network infrastructure components according to any of the preceding clauses.
Clause 14. The network system according to clause 13, wherein the network medium is electrical energy, and wherein the supply level is designed, in particular, as a DC voltage network.
Clause 15. The network system according to clause 13 or 14, wherein the network infrastructure components can be coupled to in each case at least one functional group designed as consumer, supplier and/or store.
Clause 16. The network system according to any of clauses 13 to 15, wherein at least one network infrastructure component can be coupled at least temporarily to an external monitoring system which allows observation and detection of operating parameters and service data.
Clause 17. The network system according to any of clauses 13 to 16, furthermore comprising a line system for connecting the coupled network infrastructure components.
Clause 18. The network system according to clause 17, wherein the line system comprises a supply network for the network medium and a data network for communication data.
Clause 19. The network system according to either of clauses 17 and 18, which furthermore comprises an auxiliary energy network, in particular an auxiliary voltage network.
Clause 20. The network system according to any of clauses 12 to 19, wherein furthermore at least one converter unit is provided between a network infrastructure component and a coupled functional group, in particular a voltage converter.
Clause 21. The network system according to any of clauses 13 to 20, wherein at least one coupled functional group provides a readable representation of characteristic data which can be fed to the control device of one of the network infrastructure components.
Clause 22. The network system according to any of clauses 13 to 21, wherein the network infrastructure components provide integrated load control for the entire distributed network system.
Clause 23. The network system according to any of clauses 13 to 22, wherein each contact unit and each coupling module of each network infrastructure component can be unambiguously identified.
Clause 24. The network system according to any of clauses 13 to 23, wherein a plurality of supply levels embodied by different supply lines is provided, in particular a combination of lines for electrical energy and lines for thermal energy.
Clause 25. The network system according to any of clauses 13 to 24, wherein a plurality of functional groups are provided, which are coupled to a network infrastructure component and which are designed as rechargeable energy stores, wherein the network system provides store management.
Clause 26. A use of a network system according to any of clauses 13 to 25 for the drive of a vehicle with an at least partly electrical drive.
Clause 27. A use of a network system according to any of clauses 13 to 25 as supply system for regenerative energies.
Clause 28. A use of a network system according to any of clauses 13 to 25 for operating network-independent electric tools.
Clause 29. A use of a network system according to any of clauses 13 to 25 as buffer store for foreign networks.
Clause 30. A use of a network system according to any of clauses 13 to 25 as change station for exchanging energy stores.

What is claimed is:

1. A network infrastructure component comprising the following:
at least one contact unit for connection to a further network infrastructure component, at least one coupling module for coupling a functional group, wherein the network infrastructure component is designed to communicate with a coupled functional group at least at a supply level, wherein the network infrastructure component is designed to communicate with at least one further network infrastructure component at least at the supply level and/or a data level, such that a self-configured network system for linking a plurality of functional groups can be produced with a network of a plurality of network infrastructure components.

2. The network infrastructure component as claimed in claim 1, furthermore comprising a control device for controlling operating parameters.

3. The network infrastructure component as claimed in claim 2, wherein the control device is furthermore designed to detect characteristic data of the coupled functional group.

4. The network infrastructure component as claimed in claim 2, wherein the control device is designed to take account of operating parameters of at least one further contacted network infrastructure component during the control.

5. The network infrastructure component as claimed in claim 2, wherein the control device is designed to communicate detected operating parameters at the data level to at least one further contacted network infrastructure component.

6. The network infrastructure component as claimed in claim 2, furthermore comprising at least one sensor element, wherein the at least one sensor element can be addressed by the control device.

7. The network infrastructure component as claimed in claim 1, which is furthermore designed to communicate with at least one further network infrastructure component and/or the coupled functional group at an auxiliary energy level.

8. The network infrastructure component as claimed in claim 1, which comprises an authentication unit for a user.

9. The network infrastructure component as claimed in claim 2, wherein the control device provides rule-based access rights for a user.

10. The network infrastructure component as claimed in claim 2, wherein the control device is designed to carry out load limiting and/or load disconnection for the coupled functional group.

11. The network infrastructure component as claimed in claim 1, wherein the communication at the data level with the at least one further network infrastructure component and/or the coupled functional group is carried out by means of wireless data transmission.

12. The network infrastructure component as claimed in claim 1, which furthermore comprises an identification unit, which allows the network infrastructure component and each coupling module and/or each contact unit to be unambiguously identified.

13. A distributed network system for supply purposes, which is designed for transporting a network medium at a supply level, comprising a plurality of coupled network infrastructure components each comprising the following:
at least one contact unit for connection to a further network infrastructure component, at least one coupling module for coupling a functional group, wherein the network infrastructure component is designed to communicate with a coupled functional group at least at a supply level, wherein the network infrastructure component is designed to communicate with at least one further network infrastructure component at least at the supply level and/or a data level, such that a self-configured network system for linking a plurality of functional groups can be produced with a network of a plurality of network infrastructure components.

14. The network system as claimed in claim 13, wherein the network medium is electrical energy.

15. The network system as claimed in claim 13, wherein the network infrastructure components can be coupled to in each case at least one functional group designed as consumer, supplier and/or store.

16. The network system as claimed in claim 13, wherein at least one network infrastructure component can be coupled at least temporarily to an external monitoring system which allows observation and detection of operating parameters and service data.

17. The network system as claimed in claim 13, furthermore comprising a line system for connecting the coupled network infrastructure components.

18. The network system as claimed in claim 17, wherein the line system comprises a supply network for the network medium and a data network for communication data.

19. The network system as claimed in claim 17, which furthermore comprises an auxiliary energy network.

20. The network system as claimed in claim 13, wherein furthermore at least one converter unit is provided between a network infrastructure component and a coupled functional group.

21. The network system as claimed in claim 13, wherein at least one coupled functional group provides a readable representation of characteristic data which can be fed to the control device of one of the network infrastructure components.

22. The network system as claimed in claim 13, wherein the network infrastructure components provide integrated load control for the entire distributed network system.

23. The network system as claimed in claim 13, wherein each contact unit and each coupling module of each network infrastructure component can be unambiguously identified.

24. The network system as claimed in claim 13, wherein a plurality of supply levels embodied by different supply lines is provided.

25. The network system as claimed in claim 13, wherein a plurality of functional groups are provided, which are coupled to a network infrastructure component and which are designed as rechargeable energy stores, wherein the network system provides store management.

26. The network infrastructure component of claim 2, wherein the control device is for load control at the supply level.

27. The network infrastructure component as claimed in claim 3, wherein the control device is furthermore designed to detect characteristic data of the coupled functional group at the supply level and/or the data level.

28. The network infrastructure component as claimed in claim 6, furthermore comprising at least one temperature sensor element and/or an acceleration sensor element, wherein the at least one sensor element can be addressed by the control device.

29. The network infrastructure component as claimed in claim 7, which is furthermore designed to communicate with at least one further network infrastructure component and/or the coupled functional group at an auxiliary voltage level.

30. The network infrastructure component as claimed in claim 8, wherein said authentication unit is coupled to the control device.

31. The network system as claimed in claim 14, wherein the supply level is designed as a DC voltage network.

32. The network system as claimed in claim 19, which furthermore comprises an auxiliary voltage network.

33. The network system as claimed in claim 20, wherein furthermore at least one converter unit is provided between a network infrastructure component and a coupled voltage converter.

34. The network system as claimed in claim 24, wherein a plurality of supply levels embodied by a combination of lines for electrical energy and lines for thermal energy.

35. The network infrastructure component as claimed in claim 11, wherein the communication at the data level with the at least one further network infrastructure component and/or the coupled functional group is carried out by means of electromagnetic waves.

36. The network infrastructure component as claimed in claim 11, wherein the communication at the data level with the at least one further network infrastructure component and/or the coupled functional group is carried out by means of RFID technology.

37. A method comprising the step of using a distributed network system for supply purposes for at least one of a group consisting of
the drive of a vehicle with an at least partly electrical drive,
as supply system for regenerative energies,
for operating network-independent electric tools,
as buffer store for foreign networks, and
as change station for exchanging energy stores;
wherein the distributed network system is designed for transporting a network medium at a supply level, comprising a plurality of coupled network infrastructure components each comprising the following:
at least one contact unit for connection to a further network infrastructure component, at least one coupling module for coupling a functional group, wherein the network infrastructure component is designed to communicate with a coupled functional group at least at a supply level, wherein the network infrastructure component is designed to communicate with at least one further network infrastructure component at least at the supply level and/or a data level, such that a self-configured network system for linking a plurality of functional groups can be produced with a network of a plurality of network infrastructure components.
